(19) United States
(12) Patent Application Publication
(10) Pub. No.: US 2023/0399136 A1
(43) Pub. Date: Dec. 14, 2023

(54) ITEM PACKING SYSTEM, END EFFECTOR AND METHOD OF SORTING AND/OR PACKING VINE FRUIT

(71) Applicant: WOOTZANO LIMITED, Edinburgh (GB)

(72) Inventors: Joel Maafo BUDU, Edinburgh (GB); Raviteja BURUGU, Edinburgh (GB); Jesse Kwabena OPOKU, Edinburgh (GB); Mark James BECKWITH, Edinburgh (GB); Atif SYED, Edinburgh (GB); Adnan KHADER SYED, Edinburgh (GB); Thierry Joseph Valery GARCIA, Edinburgh (GB)

(21) Appl. No.: 18/034,020

(22) PCT Filed: Oct. 26, 2021
(86) PCT No.: PCT/GB2021/052780

§ 371 Date: Apr. 26, 2023

(30) Foreign Application Priority Data
Oct. 27, 2020 (GB) 2017042.9
Apr. 19, 2021 (GB) 2105575.1
Sep. 17, 2021 (GB) 2113296.4

(51) Int. Cl. B65B 35/16; B65B 25/04; B25J 11/00; B25J 9/00; B65B 1/30; B65B 57/10

(52) U.S. Cl. CPC B65B 35/16; B65B 25/046; B25J 11/0055; B25J 9/0084; B65B 1/30; B65B 57/10

(57) ABSTRACT

An item packing system (100) configured to sort and/or pack vine fruit such as bunches of grapes into containers is disclosed herein. The system comprises a first robotic arm (110) comprising at least one first end effector (120) for cutting vine fruit, a second robotic arm (114) comprising at least one second end effector (122) for holding and manipulating a vine fruit for packing into a container, at least one camera (155) for providing image data of the vine fruit, and a controller configured to receive the image data of the vine fruit and to make a determination of the weight of the vine fruit based on the received image data. The controller is configured to control the at least one first end effector of the first robotic arm to cut the vine fruit based on the determined weight of the vine fruit, and the controller is configured to control the at least one second end effector of the second robotic arm to hold and manipulate the cut vine fruit into a container (142).

### TECHNICAL FIELD

The present disclosure relates to the field of sorting and/or packing items, such as items of fruit and/or vegetables, and in particular to vine fruit or vegetables such as bunches of grapes.

### BACKGROUND

Once fruit and/or vegetables have been grown and harvested, they are sorted and packed into containers for transport to vendors (such as supermarkets) where they are sold. Typically, this process involves a plurality of human operators who select which fruit/vegetables to select for packing, as well as sorting where these are to be packed. This sorting and packing may have to be performed in accordance with rules specific to the relevant fruit and/or vegetables. For example, grapes may have to be grouped based on weight and/or colour. This can involve a large number of human operators to perform this sorting and packing (e.g. there may be three human operators involved for packing bunches of grapes into containers). This may bring about inefficiencies in the supply chain such as limiting the throughput of fruit and/or vegetables to be sorted, as well as introducing a number of subjective judgements which the human operators will have to make to determine how to sort and/or pack the fruit and/or vegetables.

Furthermore, while processing automation for linear and fixed shape fruits like tomatoes and apples has to some extent already been done which is giving a huge improvement in their handling, very little work has been done in automating the process of nonlinear fruits like grapes, blueberries and vine tomatoes. Because of their irregular shape and size, it makes the automation complex, while at the same time quality inspection will be a very complicated task as we need to reach very narrow areas to cut the unwanted fruits.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect of the disclosure there is provided an item packing system configured to sort and/or pack non-linear fruits or vegetables, for example vine fruits or vegetables such as bunches of grapes, bananas or tomatoes, into containers. The system comprises a first robotic arm comprising at least one first end effector for cutting vine fruit, such as grapes from a bunch, a second robotic arm comprising at least one second end effector for holding and manipulating vine fruit such as a bunch of grapes for packing into a container, at least one camera for providing image data of the vine fruit; and a controller configured to receive the image data of the vine fruit and to make a determination of the weight of the vine fruit based on the received image data. The controller is configured to control the at least one first end effector of the first robotic arm to cut the vine fruit based on the determined weight of the vine fruit, and the controller is configured to control the at least one second end effector of the second robotic arm to hold and manipulate the cut vine fruit into a container. Importantly, the second robotic arm may be configured to place the cut vine fruit into a container rather than dropping them into the container.

It will be understood that when it is described that the controller is configured to determine the weight of the vine fruit it may be configured to do this from visual inspection alone. Performing a determination based on visual inspection is advantageous because it can be performed much more quickly than by conventional weighing using for example scales. Determining weight by visual inspection alone therefore may be much better suited to applications where a high throughput of items/objects need to be packed as quickly as possible. Furthermore, when handling items, for example vine fruit such as a bunch of grapes, weighing the bunch for example by lifting the bunch can be problematic because some grapes can fall off the bunch and/or if the bunch is held incorrectly it can fall apart.

It will also be understood that while the system is described with reference to its use with bunches of grapes, it could equally be applied to other non-linear objects, for example other vine fruit such as other bunches or groups of fruits and vegetables that need sorting (e.g. by weight) into containers such as punnets, for example blueberries, bananas and vine tomatoes.

Additionally, or alternatively, the controller may be configured to determine the mass of the vine fruit from visual inspection alone. In some examples the controller may be configured to determine the weight or mass of a vine fruit by determining a region of interest within image data and applying a mask to the region of interest, wherein the mask covers or identifies the vine fruit. The weight of the vine fruit may be determined, for example via linear regression, based on the area of the mask, for example based on the number of pixels in the mask.

In some examples the controller may be configured to determine the type/species of vine fruit and determine the weight and/or mass of the vine fruit based on the determined type/species and an estimated size (e.g. in terms of volume) of the vine fruit. The determination of the type/species may be performed by image recognition, for example using a pre-trained machine learning algorithm. The determination/estimation of the size may be performed, for example, using a point cloud analysis and/or semantic image segmentation.

The at least one second end effector may comprise a pressure sensing assembly for providing an indication of a contact pressure, and the controller may be configured to control the at least one second end effector of the second robotic arm to hold and manipulate the cut vine fruit into a container based on an indication of the contact pressure. In some examples the at least one second end effector may comprise a pair or more of end effectors for determining a contact pressure of an item/vine fruit held there between. In some examples the at least one second end effector may comprise a scoop or a scooped portion for supporting the underside of a vine fruit when held and manipulated by the at least one second end effector.

The pressure sensing assembly may comprise a plurality of different contact points on digits of an end effector which may be each arranged to enable an indication of the pressure being applied to the fruit or vegetable by that region of the digit to be obtained. The pressure sensing assembly may be configured to give a plurality of sensor readings in the time period for grasping an item of fruit or vegetable (e.g. from a plurality of different contact locations on the digit). The system may be configured to monitor the pressure on the fruit or vegetable during the process of picking and placing into a container. The pressure may be used to determine when it is safe to lift an item of fruit or vegetable (e.g. once the pressure is above a threshold level), and/or whether the item is being held correctly (e.g. if it is moving relative to one or more of the digits). The system may be configured to control movement of the digits based on the pressure reading. For example, in the event that the pressure is too low in one or more regions (e.g. it is below a threshold value), or is decreasing, the digits may be moved to increase this pressure (moved towards each other, and/or in a direction based on a determined direction of movement for the item). Likewise, digits may be moved apart if the pressure is too high. The system may be configured to use pressure readings to determine that the fruit or vegetable is held securely enough to be moved, but not too tightly that it will be damaged during movement.

At least one camera may be proximate to the first robotic arm, and additionally or alternatively at least another camera may be proximate to the second robotic arm. The controller may be configured to receive image data of a vine fruit to be cut proximate to the first robotic arm, and/or the controller may be configured to receive image data of a cut vine fruit proximate to the second robotic arm and to make a determination of the weight of the cut vine fruit based on the received image data from the at least another camera. The controller may be configured to make a determination as to whether to pack the cut vine fruit into a container based on the determined weight of the cut vine fruit. In some examples the controller may be configured to determine which container to pack the cut vine fruit into or select a container from a plurality of containers to pack the cut vine fruit in to based on the determined weight of the cut vine fruit and/or a target weight.

In some examples the controller may have already packed a cut vine fruit into a container, but the container is still below a target weight. In such examples the controller may be configured to cut a new vine fruit such as a new bunch of grapes based on the difference between the target weight and the vine fruit already placed in the container. For example, the controller may determine a difference weight and may be configured to control the first robotic arm and the at least one first end effector to cut the vine fruit to obtain a cut vine fruit having a weight approximately equal to the difference weight.

The item packing system may comprise a conveyor configured to convey a vine fruit to the first robotic arm and from the first robotic arm to the second robotic arm. The controller may be configured to control the conveyor based on operation of the first robotic arm and/or the second robotic arm. The controller may be configured to control the conveyor based on control of at least one of the at least one first end effector of first robotic arm and/or the at least one second end effector of second robotic arm. For example, the controller may be configured to control the conveyor in response to the at least one first end effector of the first robotic arm cutting a vine fruit. For example, as the vine fruit is being cut, the controller may be configured to control operation of the conveyor to separate the cut vine fruit from the remainder, to make it easier for the second robotic arm to hold and manipulate the cut vine fruit.

The item packing system may comprise a mechanism to change or flip the orientation of the fruit such that a different face of the vine fruit is exposed to the at least one camera. This mechanism may be proximate to the first robotic arm and/or in the field of view of the camera. The controller may be configured to make a second determination of the weight of the vine fruit based on received image data relating to the different exposed face of the flipped vine fruit. The controller may be configured to compare the second determined weight of the vine fruit with the determined first weight of the vine fruit. The controller may then average the two weights to obtain an average determined weight of the vine fruit. Additionally, or alternatively, if the difference between the two determined weights is greater than a selected threshold difference, the controller may be configured to control the item packing system to repeat the weight determinations and or to flag an error condition. This may result in the vine fruit being rejected and/or requesting intervention from a user/operator of the system.

The item packing system may additionally or alternatively comprise a colour depth camera. This may use stereo depth sensing and/or light detection and ranging, LIDAR, apparatus for determining a distance to the item and/or for determining the weight of the vine fruit. The type of depth sensing depends on the level of accuracy required for analysis and other factors. In some examples there may be provided a plurality of cameras to provide different angled views of the vine fruit.

The system may be configured to use a determined distance to the item to facilitate picking and/or to determine item size. The system may comprise at least one of: (i) a chemical sensor for detecting the chemical composition of the item held by said end effector, (ii) a ripeness sensor for detecting the ripeness of the item held by said end effector, and (iii) a firmness sensor for detecting how firm the item is, for example wherein the firmness sensor comprises a camera configured to perform visual inspection of the item. For example, one or more of the end effectors may comprise the chemical sensor, ripeness sensor and/or firmness sensor, and/or such sensors may be provided by additional components of the system, e.g. the sensors may be provided at least in part by a visual inspection system (e.g. one or more cameras and a controller configured to perform image analysis of images of the items obtained by the cameras). The system may be controlled based on an obtained indication of ripeness, such as to sort items based on their ripeness (e.g. group items of similar ripeness into the same containers, or organise containers so that each container has items at different levels of ripeness therein). Overly ripe items may be discarded, as may items which are too soft or firm. The at least one end effector may comprise three digits. Each digit may have a corresponding pressure sensor or pressure sensing assembly.

In some examples the controller is configured to obtain point cloud information to determine the weight of the vine fruit. In some examples the controller is configured to perform semantic image segmentation on the received image data to determine the location of stems or stalks relative to the fruit on the vine, and wherein the controller is configured to use the determined location of stems or stalks to control the at least one end effector of the first robotic arm to cut the vine fruit at a stem or stalk.

The controller may be configured to determine an orientation to hold the vine fruit in based on the received image data. For example, the controller may be configured to determine an orientation to hold the vine fruit in based on the determined location of stems or stalks.

In some examples the controller may be configured to determine the condition of the vine fruit based on received image data, for example based on received image data from a camera proximate to the first robotic arm. The controller may be configured to determine if the vine fruit or a portion thereof (for example, grapes on a bunch) have appearance characteristics outside of a selected threshold range of appearance characteristics. The controller may be configured to detect various type of defects present on the fruit. For example, the controller may be configured to determine if the vine fruit (such as any of the grapes on a bunch) appear blemished and/or bruised. In the event that the controller determines that at least a portion of the vine fruit (for example some of the grapes of the bunch) are blemished and/or bruised (for example, above a selected threshold acceptable level), the controller may be configured to control the first robotic arm and the at least one first end effector to cut off the blemished and/or bruised fruit from the vine. Alternatively, if the number of blemished and/or bruised fruit on the vine (such as the number of grapes) exceeds a selected proportion of the vine fruit, the controller may be configured to control the system to discard the entire vine fruit entirely.

In examples where the at least one second end effector comprises a pressure sensing assembly, the controller may be configured to receive sensor signals from the pressure sensing assembly of the second robotic arm to obtain an indication of:
a magnitude of contact pressure for contact between the end effector and the item held by the end effector; and
(ii) a direction of contact pressure for contact between the end effector and the item held by the end effector; and

wherein the controller is configured to determine whether the end effector is correctly holding the item based on the indication of the magnitude of the contact pressure and the indication of the direction of contact pressure.

The controller may be configured to determine if the end effector is correctly holding the item if both: (i) the indication of the magnitude of contact pressure is within a selected pressure range, and (ii) the indication of the direction of contact pressure is within a selected direction range.

The controller may be configured to determine that the end effector is not correctly holding the item if at least one of:
(i) the indication of the magnitude of contact pressure has increased or decreased by more than a first amount;
(ii) the indication of the magnitude of contact pressure is increasing or decreasing by more than a first rate of change;
(iii) the indication of the direction of contact pressure has changed by more than a second amount; and
(iv) the indication of the direction of contact pressure is changing by more than a second rate of change.

The controller may be configured to determine that the end effector is not correctly holding the item if at least one of:
(i) the indication of the magnitude of contact pressure is changing while the indication of the direction of contact pressure remains constant; and
(ii) the indication of the direction of contact pressure is changing while the indication of the magnitude of contact pressure remains constant.

In the event that the controller determines that the one or more end effectors are not correctly holding the item, the controller may be configured to control at least one of the end effectors to move relative to the item.

Controlling at least one of the end effectors to move may comprise at least one of:
(i) moving the end effector inwards to increase its contact pressure on the item in the event that the magnitude of contact pressure is too low;
(ii) moving the end effector outwards to decrease its contact pressure on the item in the event that the magnitude of contact pressure is too high; and
(iii) moving the end effector around the item to a different location on the surface of the item in the event that the direction of contact pressure is not in the correct direction.

In the event that the system determines that the one or more end effectors are not holding the item correctly, the system may perform at least one of the following actions:
(i) rejects the item for review;
(ii) logs the rejection in a database, optionally with a timestamp;
(iii) triggers an alert notification;
(iv) returns the item to where it was picked, for example to enable further visual inspection of the item;
(v) attempts to obtain a new indication of the size of the item;
(vi) determines if the item is bruised or damaged; and
(vii) provides feedback for use in training a machine learning algorithm.

The pressure sensing assembly of the second robotic arm may comprise an electronic skin made from a substrate comprising:
a base polymer layer;
a first intermediate polymer layer attached to the base polymer layer by a first adhesive layer, the first intermediate polymer layer comprising a first intermediate polymer in which electron-rich groups are linked directly to one another or by optionally substituted C₁₋₄ alkanediyl groups; and
a first conductive layer attached to the first intermediate polymer layer by a second adhesive layer or by multiple second adhesive layers between which a second intermediate polymer layer or a second conductive layer is disposed. Nanowires may be present on the first conductive layer. The nanowires may comprise a piezoelectric material. Said nanowires may be provided to enable piezoelectric pressure sensing.

The nanowires may comprise a conductive material, and preferably a metallic conductive material, where the metal in the metallic conductive material is preferably selected from zinc and silver, and more preferably is zinc, e.g. in the form of zinc oxide. The metallic conductive material may be in a crystalline form. The nanowires may extend away from the surface of the first conductive layer. A first end of the nanowires may be tethered to the first conductive layer. The nanowires may have an aspect ratio of from 1.5 to 100, preferably from 4 to 50, and more preferably from 6 to 20. The nanowires may be substantially vertically aligned. The nanowires, e.g. the surface of the nanowires may be functionalised with a species which enhances the sensory, e.g. piezoresistive or piezoelectric, response of the electronic skin when it comes into contact with a target species, for instance the nanowires may be functionalised with a binder, a catalyst or a reagent. The nanowires may be functionalised with a functional group, preferably selected from amino (—NH₂), hydroxy (—OH), carboxy (—COOH), amido (—CONH₂) and sulfanyl (—SH) groups. The nanowire may be functionalised with a catalyst, the catalyst preferably cleaving a target species into sub-sections, with one of the sub-sections inducing a sensory response in the electronic skin.

The substrate may comprise a pair of electrical contacts through which a sensory response of the nanowires is transmitted. For example, said substrate may provide pressure sensing for the digits, e.g. the pressure sensor may comprise the electronic skin on the digits. The substrate may comprise a third conductive layer to which the second end of each nanowire is preferably tethered. A sensory, e.g. piezoelectric, response of the nanowires may be transmitted through a pair of electrical contacts, one of which is attached to the first conductive layer and the other of which is attached to the third conductive layer. The first and third conductive layers may be attached to one another by a third adhesive layer or, preferably, by multiple (e.g. two) third adhesive layers between which a third intermediate polymer layer is disposed. The conductive layer may have a thickness of from 10 to 300 nm, preferably from 25 to 200 nm, and more preferably from 50 to 100 nm. The electronic skin may comprise electrical connection means which are suitable for electrically connecting the conductive layer, e.g. via the electrical contacts, to a signal receiver (e.g. a computer such as the control unit), the electrical connection means being preferably selected from wires, flex circuits and plug and play slots; and/or a support to which the one or more substrates are attached.

In another aspect there is provided a method of sorting and/or packing vine fruit such as grapes into containers by a robotic system. The robotic system comprising a first robotic arm comprising at least one first end effector for cutting vine fruit, such as grapes from a bunch, and a second robotic arm comprising at least one second end effector for holding and manipulating a vine fruit for packing into a container. The method comprises receiving image data of the vine fruit, making a determination of the weight of the vine fruit based on the received image data, making a determination as to where to cut the vine fruit based on the determined weight of the vine fruit, controlling the at least one first end effector of the first robotic arm to cut the vine fruit, and controlling the at least one second end effector of the second robotic arm to hold and manipulate the cut vine fruit into a container.

The at least one second end effector may comprise a pressure sensing assembly for providing an indication of a contact pressure and wherein the method comprises controlling the at least one second end effector of the second robotic arm to hold and manipulate the cut vine fruit into a container based on the indication of the contact pressure.

The at least one second end effector may comprise a plurality of end effectors. The at least one second end effector may comprise a plurality of digits. The method may further comprise receiving an indication of a magnitude of contact pressure of an item between the plurality of digits, receiving an indication of a direction of contact pressure of an item between the plurality of digits, and determining whether the plurality of digits are correctly holding the item based on the indication of the magnitude of the contact pressure and the indication of the direction of contact pressure.

In another aspect there is provided an end effector for a robotic arm for manipulating an item, for example vine fruit such as bunches of grapes. The end effector comprises a pair of opposing scoops coupled via a connecting portion, wherein each opposing scoop comprises a plurality of digits and wherein each digit comprises a pressure sensing means. The pressure sensing means may comprise the pressure sensing assembly described above. For example, the pressure sensing means may comprise an electronic skin optionally comprising nanowires. The pressure sensing means are arranged to detect or obtain an indication of at least one of the magnitude and the direction of pressure on each of the digits caused by the item. In some examples all of the digits may have pressure sensing means, although in other examples only some of the digits may have pressure sensing means. In some examples each scoop may additionally or alternatively comprise pressure sensing means. it will be understood that each scoop is may be configured to be similar to (for example, provide similar functionality to) that of the palm of a human hand, with each digit being similar to (for example, provide similar functionality to) that of a human's fingers.

Each digit may comprise a curved fingertip comprising an extrusion configured to support vine fruit. The curved fingertip may advantageously help to get underneath vine fruit, such as a bunch of grapes, when resting on a surface, to help support the vine fruit when lifted to prevent or reduce the chance of vine fruit falling off the vine when being manipulated/lifted by the end effector.

The end effector may further comprise a controller, and the controller may be configured to control operation of at least one of (i) at least one of the scoops and (ii) at least one digit based on the detected magnitude and/or direction of pressure. It will be understood that the controller may be the same controller as that provided for the packing system described above.

The controller may be configured to determine whether an end effector is correctly holding an item based on an indication of whether the vine fruit is moving relative to the digits, and wherein the controller is configured to control the end effector to manipulate at least one of the digits in response to a determination that the end effector is not correctly holding the vine fruit.

The controller may be configured to determine the approximate shape of the item based on the at least one the magnitude and the direction of pressure on each of the digits, and wherein the controller is configured to manipulate at least one of (i) at least one of the scoops and (ii) at least one digit based on the determined approximate shape.

The controller may be configured to determine if the end effector is correctly holding the item if both: (i) the indication of the magnitude of contact pressure is within a selected pressure range, and (ii) the indication of the direction of contact pressure is within a selected direction range.

The controller may be configured to determine that the end effector is not correctly holding the item if at least one of:
(i) the indication of the magnitude of contact pressure has increased or decreased by more than a first amount;
(ii) the indication of the magnitude of contact pressure is increasing or decreasing by more than a first rate of change;
(iii) the indication of the direction of contact pressure has changed by more than a second amount; and
(iv) the indication of the direction of contact pressure is changing by more than a second rate of change.

The controller may be configured to determine that the end effector is not correctly holding the item if at least one of:
(i) the indication of the magnitude of contact pressure is changing while the indication of the direction of contact pressure remains constant; and
(ii) the indication of the direction of contact pressure is changing while the indication of the magnitude of contact pressure remains constant.

In the event that the controller determines that the one or more end effectors are not correctly holding the item, the controller may be configured to control at least one of the end effectors and/or each or one of the scoops to move relative to the item.

Controlling at least one of the end effectors to move may comprise at least one of:
(i) moving the end effector, a digit or a scoop inwards to increase its contact pressure on the item in the event that the magnitude of contact pressure is too low;
(ii) moving the end effector, a digit or a scoop outwards to decrease its contact pressure on the item in the event that the magnitude of contact pressure is too high; and
(iii) moving the end effector, a digit or a scoop around the item to a different location on the surface of the item in the event that the direction of contact pressure is not in the correct direction.

In the event that the system determines that the one or more end effectors are not holding the item correctly, the system may perform at least one of the following actions:
(i) rejects the item for review (for example by placing the item in a container designated as waste);
(ii) logs the rejection in a database, optionally with a timestamp;
(iii) triggers an alert notification;
(iv) returns the item to where it was picked, for example to enable further visual inspection of the item;
(v) attempts to obtain a new indication of the size of the item;
(vi) determines if the item is bruised or damaged; and
(vii) provides feedback for use in training a machine learning algorithm.

In another aspect there is provided an apparatus for sorting vine fruit such as bunches of grapes. The apparatus comprises a hopper for receiving vine fruit such as bunches of grapes and a chute for receiving vine fruit, the chute having a first open end for receiving a vine fruit from the hopper, and a second open end configured to release the vine fruit to a conveyor. The apparatus may further comprise a camera and a rotating means, the rotating means configured to rotate a vine fruit in front of the camera to enable the camera to obtain a plurality of different images of the vine fruit. The camera and rotating means may be coupled to a controller, and the controller may be configured to operate the camera and rotating means to obtain a plurality of still frames of the vine fruit viewed from different orientations, for example the controller may be configured to analyse the plurality of still frames to determine if any regions of the vine fruit contain blemishes or defects.

It will be understood that the item packing system may comprise the apparatus for sorting vine fruit such as bunches of grapes.

Pressure sensing assemblies of the present disclosure may comprise a contact pressure sensing assembly comprising: an electronic skin for the digits of the end effector of the robotic arm, wherein the electronic skin may comprise: (i) a plurality of piezoresistive sensors each configured to obtain piezoresistive signals; and (ii) a plurality of piezoelectric sensors each configured to obtain piezoelectric signals, thereby to provide the pressure sensing assembly. A controller of the present disclosure may be coupled to the electronic skin to receive the piezoresistive and piezoelectric signals therefrom. The controller may be configured to process the piezoresistive signals to identify one or more piezoresistive parameters associated therewith, and to process the piezoelectric signals to identify one or more piezoelectric parameters associated therewith. The controller may be operable to identify that an item held by the digits of the end effector is moving relative to the electronic skin based on a difference in magnitude and/or phase between: (i) one or more of the piezoelectric parameters in piezoelectric signals from one piezoelectric sensor, and (ii) one or more of the piezoelectric parameters in piezoelectric signals from another piezoelectric sensor. The controller may be configured to determine a contact pressure between the item and a first digit associated with said one piezoelectric sensor based on one or more of the piezoresistive parameters from piezoresistive signals associated with the first digit.

Such a contact pressure sensing assembly may enable more responsive and/or precise pressure sensing, as well as to enable more reliability in pressure sensing, as results from piezoelectric sensors may provide complementary information to that obtained using piezoresistive sensors (and vice versa). For example, the combination of sensor data may enable the assembly to perform a cross-checking or comparison between sensor data (e.g. to increase reliability that a measurement from one type of sensor is correct). The assembly may be able to detect an indication of a change in pressure (e.g. due to some movement of the item relative to the digit) using the piezoelectric sensors, and to monitor an indication of the contact pressure (e.g. its magnitude/direction etc.) using the piezoresistive sensors. This may enable quicker detection of movement in combination with real-time monitoring of contact pressure.

In response to identifying that an item held by the digits of the end effector is moving relative to the electronic skin for the first digit based on the piezoelectric signals, the controller may be configured to monitor piezoresistive signals associated with the first digit to confirm that the item is moving relative to the electronic skin for the first digit. The controller may be configured to determine a direction of movement of the item based on a phase difference between different piezoelectric signals. For at least one of the digits of the end effector, the electronic skin may comprise a first piezoelectric sensor and a second piezoelectric sensor located away from the first piezoelectric sensor. The controller may be configured to determine whether the item is moving in the direction of the first piezoelectric sensor or the second piezoelectric sensor based on piezoelectric signals from the first and second piezoelectric sensors. The one or more piezoresistive parameters may comprise a change in voltage associated with the sensor, and/or wherein the one or more piezoelectric parameters comprise any of: a maximum voltage, a minimum voltage, a change in voltage and/or a rate of change of voltage. The controller may be configured to control at least one of the digits to move relative to the item, wherein the controller is configured to determine a direction in which the digit is to move based on the determined direction of movement of the item. In the event that the controller determines that the item is moving relative to a first digit, the controller may be configured to determine a contact pressure between the item and the first digit based a change in voltage from piezoresistive signals on the first digit. For example, the controller may control the digit to move to a location where it can oppose the direction of movement of the item.

The pressure sensing assembly may be configured to obtain a spatial distribution of contact pressure for contact between the digits and the item held by the digits based on contact pressure measurements at each of a plurality of different locations on the digits. The system may be configured to identify an indication of directionality in the contact pressure between the digits and the item based on the spatial distribution of contact pressure. The system may be configured to determine whether the digits are correctly holding the item based on the spatial distribution of contact pressure and the indication of directionality in the contact pressure between the digits and the item.

The system may be configured to receive an indication of the type of item of fruit or vegetable. The selected range for pressure may be selected based on the indication of the type of item of fruit or vegetable. For example, the system may be configured to obtain an indication of suitable pressure values for each type of fruit and/or vegetable used in the system. Based on the obtained indication of the type of item, the system may be controlled so that the pressure remains within the selected range for that particular type of item. The system may be configured to receive an input indicating the type of item (e.g. from an image processing element of the system or as input from a human operator of the system). Based on the input of type of item, the system may identify the selected ranges for pressure (e.g. based on historic data).

In examples, the system may comprise a displacement sensor configured to obtain an indication of relative displacement between the end effectors, e.g. between the different digits. The packing system may be configured to determine that the end effector is not correctly holding the item of fruit or the vegetable if at least one of: (i) the indication of pressure (magnitude and/or direction) is changing while the indication of displacement remains substantially constant, and (ii) the indication of displacement is changing while the indication of pressure (magnitude and/or) remains substantially constant. For example, (i) may represent slipping of the item, and/or (ii) may represent squashing of the item. Changing may comprise a total change in value above a threshold amount, or a change at or above a selected rate of change.

The displacement sensor may be provided, at least in part, by a camera (e.g. one of the cameras mentioned above). The system may be configured to allocate the item of fruit or the vegetable to one of a selected number of containers or containers based on the indication of the size. For example, the system may be configured to identify a plurality of open containers (e.g. non-full containers into which items are to be placed). The system may be configured to identify one or more selection criteria associated with each open container, such as an indication of a requirement for one or more properties of an item which is to be placed into said open container. For example, selection criteria for an item to be placed into an open container may comprise an indication of at least one of: (i) a size of an item, (ii) a shape of an item, (iii) a colour of an item, (iv) a ripeness and/or firmness of an item, (v) a type of item, (vi) a chemical composition of an item, and/or (vii) a suitability of an item such as a number of deficiencies associated with that item. The system may be configured to identify relevant properties of an item to be packed and to select the open container into which that item is to be placed based on the one or more properties associated with the item and the relevant selection criteria associated with the open containers. For example, the system may be configured to obtain an indication of the property of the item (e.g. its size) and to select an open container based on that property (e.g. an open container intended to receive items of that size). In the event that there is a match (e.g. a suitable open container for that item), the system is configured to place that item in said container.

The system may be configured to allocate the item of fruit or the vegetable to one of a selected number of containers based (i) on the indication of the size of the item of fruit or the vegetable and (ii) based on the remaining space in each of the selected containers. A data store of the system may store an indication of open containers and what spaces they have available (as well as criteria associated with open containers which specify which items are to be placed in said containers), and/or container availability may be determined on-the-fly, such as using a camera to identify open spaces.

Aspects of the present disclosure may provide a computer readable non-transitory storage medium comprising a program for a computer configured to cause a processor to perform any of the methods disclosed herein.

### FIGURES

Some examples of the present disclosure will now be described, by way of example only, with reference to the figures, in which:

FIG. 1 shows a schematic diagram of an exemplary system for sorting and/or packing items such as grapes in a plan view.

FIG. 2 shows a perspective view of another exemplary system for sorting and/or packing items such as grapes in a plan view.

FIG. 3 shows a perspective view of an example end effector for use in cutting a vine fruit such as a bunch of grapes.

FIG. 4 shows a perspective view of an example end effector for grasping, holding and/or manipulating a vine fruit such as a bunch of grapes.

FIG. 5 shows two bunches of grapes on a conveyor identified within regions of interest and with masks applied.

FIG. 6 shows an image of an example bunch of grapes and the same bunch of grapes with the stems/stalks highlighted for use in training a machine learning model to identify the stems in bunches of grapes.

FIG. 7 shows a schematic diagram of another exemplary system for sorting and/or packing items such as grapes in plan view.

FIGS. 8A-D show views of another example end effector for grasping, holding and/or manipulating vine fruit such as a bunch of grapes.

FIGS. 9A and 9B show views of an example system for calibrating the relationship between a camera and the physical position a robotic arm occupies within the field of view of the camera.

In the drawings like reference numerals are used to indicate like elements.

### SPECIFIC DESCRIPTION

Embodiments of the present disclosure are directed to systems and methods for sorting and/or packing items, such as items of fruit and/or vegetables. A robotic arm is used in combination with an end effector coupled to the end of the robotic arm. The end effector is operable to grasp an item of fruit or vegetable (e.g. the end effector may comprise one or more digits). A pressure sensing assembly is used to identify a property of the item of fruit or vegetable which is grasped by the end effector, such as its size, shape, ripeness or whether the item is held correctly (e.g. whether it is moving relative to the digits). The robotic arm may then control movement of the item of fruit or vegetable, e.g. to place it into a container which is selected based on this identified property. Embodiments of the disclosure are also directed to systems and methods which utilise one or more cameras to determine one or more properties of the item of fruit and/or vegetable, such as colour, shape, or any other property indicative of where that item should be placed (e.g. whether it should be discarded). Embodiments may utilise machine learning to provide improved image detection and classification of items of fruit and/or vegetables.

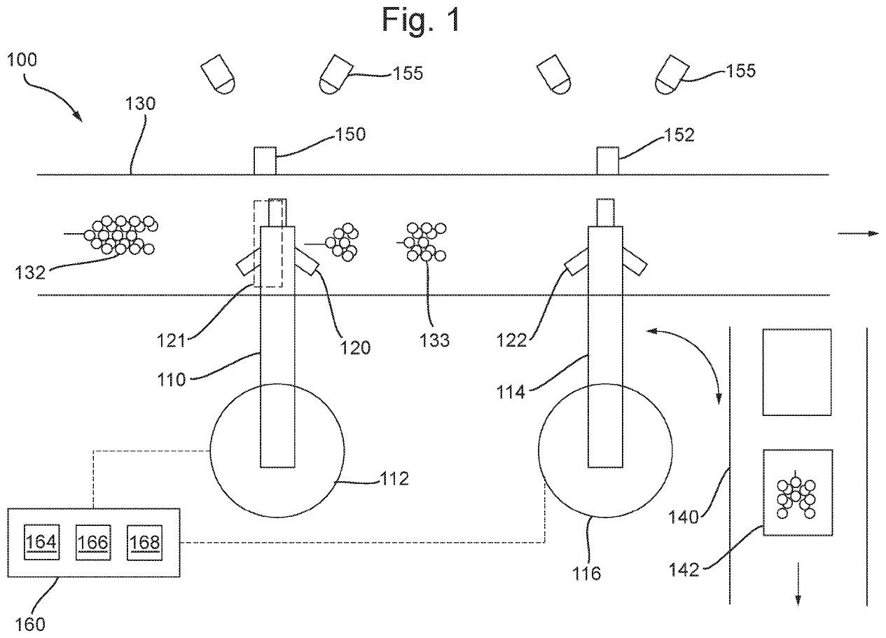

An exemplary fruit and/or vegetable packing system will now be described with reference to FIG. 1.

FIG. 1 shows an item packing apparatus or system 100 adapted for picking grapes. However, it will be understood that the item picking apparatus or system 100 of FIG. 1 may be adapted for use with other non-linear objects, such as other non-linear fruits and vegetables, such as bunches of bananas or other vine fruits or vegetables such as tomatoes.

The system 100 comprises a first robotic arm 110 comprising at least one first end effector 120 for cutting grapes from a bunch. The at least one first end effector 120 may comprise a cutting means for cutting grapes from a bunch. The system 100 also comprises a second robotic arm 114 spaced from the first robotic arm 110 along a first conveyor 130. The second robotic arm 114 comprises at least one second end effector 122 for holding and manipulating a bunch of grapes for packing into a container 142. The first and second robotic arms 110, 114 are provided on respective movable platforms 112, 116. The fact that they are movable may mean that they can be taken out of the way if the task is to be performed manually. The movable platforms 112, 116 may each comprise a controller such as a local controller for controlling each robotic arm 110, 114 and its respective end effectors 120, 122.

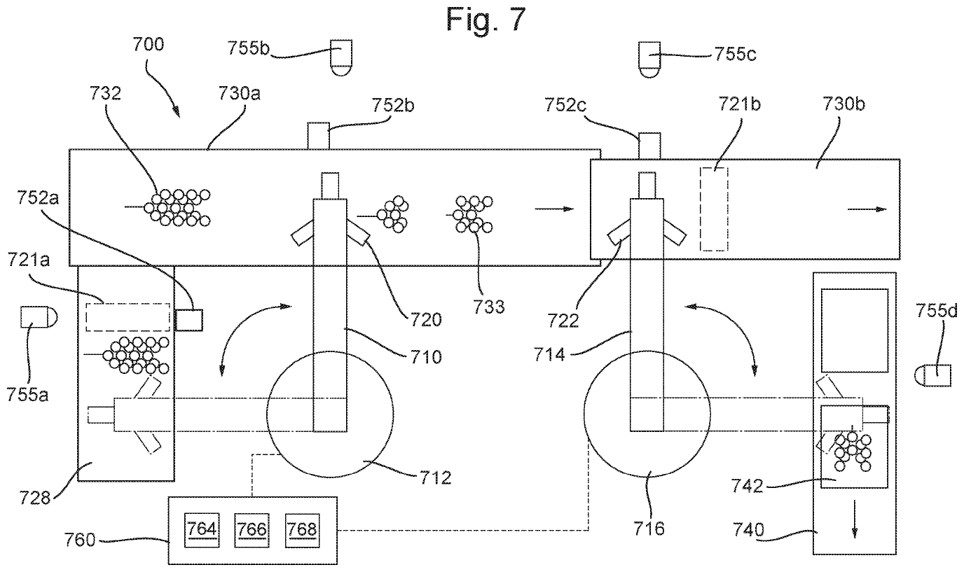

In the example shown in FIG. 1, the system 100 further comprises a pair of cameras 155 arranged to view a region of the first conveyor 130 proximate to each robotic arm 110, 114 such that in the example shown in FIG. 1 there are four cameras 155, two for each robotic arm 110, 114. However, it will be understood that in other examples there may only be one camera 155 for each robotic arm 110, 114 (for example as indicated in the example of FIG. 7 described in more detail below) and/or one of the cameras may be replaced with a light detection and ranging, LI DAR, apparatus.

The system may include one or more lighting elements. The lighting elements may be configured to direct light to a region in which the cameras 155 are configured to obtain images of the items. For example, the one or more lighting elements may be configured so that each camera 155 obtains pictures of an illuminated item. The one or more lighting elements may be connected to the cameras 155 and/or controller to enable lighting to be timed so that it is on when images are to be obtained. For example, each camera 155 may have its own associated light.

The system 100 also comprises a controller 160 which includes data store 164, processor 166 and a communications interface 168. The controller 160 may additionally or alternatively include a graphical user interface, GUI (not shown). In some examples the functionality of the controller may be provided by a (local) controller mounted in the movable platform 112, 116 of one of the robotic arms 110, 114, for example such that one (local) controller is configured to act as a “master” controller and the other controller is configured to act as a “slave” controller.

The system 100 also comprises an optional second conveyor 140, which in the example shown is travelling perpendicular to the first conveyor 130 and is reachable by the second robotic arm 114, such that the second robotic arm 114 can hold and manipulate a cut bunch of grapes from the first conveyor 130 into containers 142 on the second conveyor 140. The second conveyor 140 may then carry the packed containers 142 away for sealing/packaging. In the example shown the first conveyor 130 and the second conveyor 140 are movable belts configured to transport items such as fruits disposed thereon. However, in other examples at least one of the conveyors 130, 140 may be static. It will also be understood that in other examples the second conveyor 140 may be parallel to the first conveyor 130.

In some examples at the end of the first conveyor 130 there is a collector for collecting loose grapes e.g. grapes that have fallen off of the bunch. The loose grapes collected in the collector may be used for packing, for example by the second robotic arm 114.

In the example shown in FIG. 1 there is a respective light gate which in this case is an infra-red sensor 150, 152 proximate to each robotic arm 110, 114. The infra-red sensors 150, 152 are configured to determine the presence of an object/item on the conveyor 130 proximate to each robotic arm 110, 114. The controller may be configured to use sensor inputs from each infra-red sensor 150, 152 to control operation of each robotic arm 110, 114 and/or control operation of the conveyor 130. Although an infra-red sensor is described, other types of sensors configured to determine the presence of an object/item such as a bunch of grapes on the conveyor 130 may be used. For example, the conveyor 130 may comprise pressure sensors underneath configured to detect the presence of an object/item on the conveyor 130. In some examples the second conveyor 140 may also comprise an infra-red sensor configured to determine the presence of a container 142. Additionally, or alternatively, the conveyor 140 may comprise a weight sensor configured to determine the weight of a container 142 and/or fruit such as a cut bunch of grapes 133 placed in them. In some examples the weight sensor may serve as a validation tool for the vision weight estimation algorithm employed by the controller 160. It will be understood that the data obtained from the weight sensor may be used to improve the machine learning, for example via reinforcement. In some examples if the determination of the weight from the weight sensor differs from the expected weight (for example the weight determined by the controller 160 by visual inspection with the cameras 155) by more than a selected threshold, this may result in the container 142 being discarded and/or a notification being sent indicating that manual inspection of the container 142 is required. For example, if the determination of the weight from the weight sensor differs from the expected weight (for example the weight determined by the controller 160 by visual inspection with the cameras 155) by more than a selected threshold, the controller 160 may flag an error condition. This may result in the bunch of grapes being rejected and/or requesting intervention from a user/operator of the system. In some examples this may involve the second robotic arm 114 holding and manipulating the bunch of grapes and placing them in a waste bin or container.

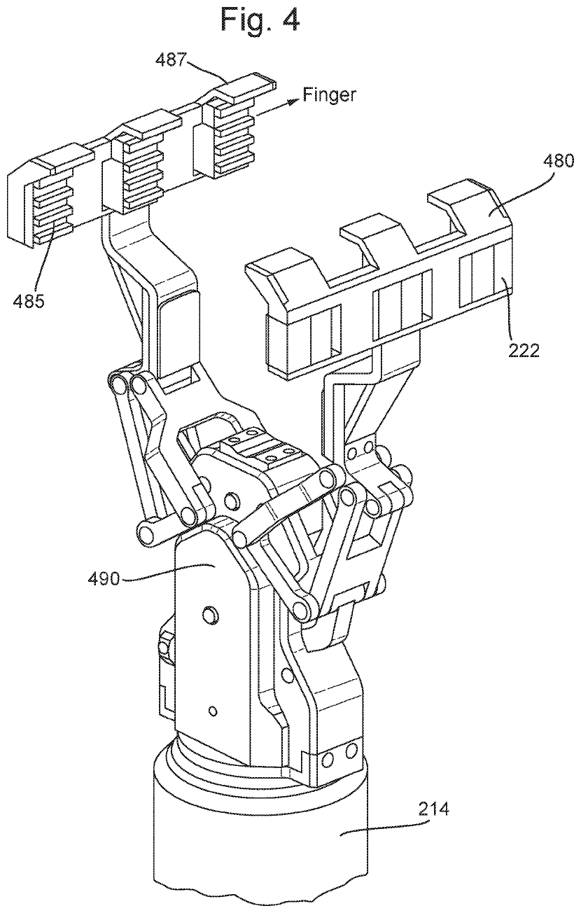

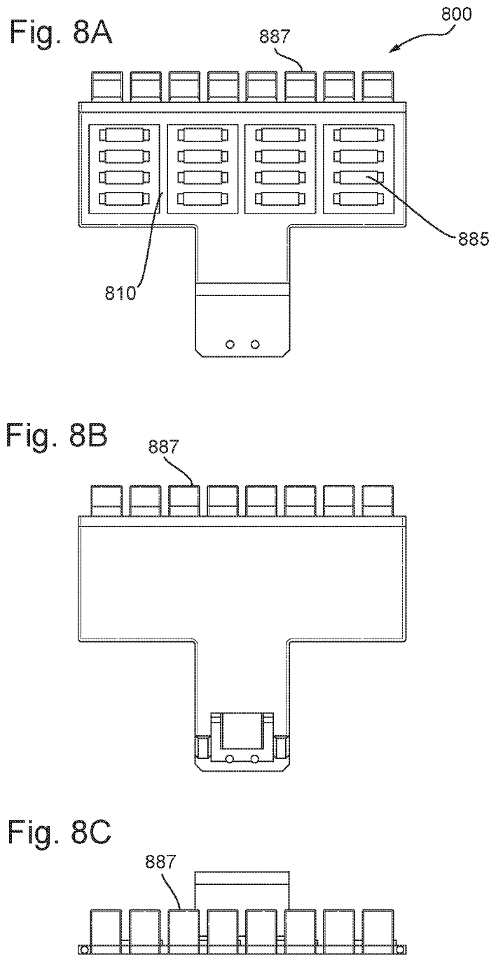

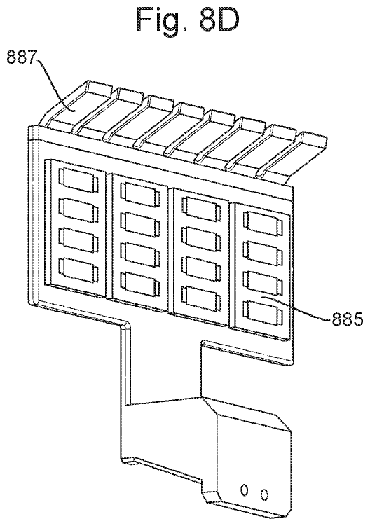

The at least one second end effector 122 may comprise a pressure sensing assembly for providing an indication of a contact pressure. The pressure sensing assembly may comprise a pressure sensing assembly (as described in more detail below with reference to FIGS. 4 and 8). The pressure sensing assembly may comprise: (i) a plurality of piezoresistive sensors each configured to obtain piezoresistive signals; and (ii) a plurality of piezoelectric sensors each configured to obtain piezoelectric signals, thereby to provide the pressure sensing assembly. In some examples the at least one second end effector 122 may comprise a pair or more of end effectors for determining a contact pressure of an item/bunch of grapes held there between. In some examples the at least one second end effector 122 may comprise a scoop or a scooped portion (as shown in FIG. 4 described in more detail below) for supporting the underside of a bunch of grapes when held and manipulated by the at least one second end effector 122. The scoop or scooped portion may comprise a plurality of digits, and each digit may comprise a portion with an electronic skin.

The cameras 155 are arranged to provide image data of a bunch of grapes travelling on the conveyor 130. The controller is configured to receive the image data of the bunch of grapes and to make a determination of the weight of the bunch of grapes based on the received image data. The controller may be configured to receive image data of a bunch of grapes to be cut from a pair of cameras 155 proximate to the first robotic arm 110, and/or the controller may also be configured to receive image data of a cut bunch of grapes from a pair of cameras 155 proximate to the second robotic arm 114 and to make a determination of the weight of the cut bunch of grapes based on the received image data from the pair of cameras 155 proximate to the second robotic arm 114. The controller may be configured to make a determination as to whether to pack the cut bunch of grapes into a container 142 based on the determined weight of the cut bunch of grapes. In some examples the controller may be configured to determine which container 142 to pack the cut bunch of grapes into or select a container 142 from a plurality of containers 142 to pack the cut bunch of grapes in to based on the determined weight of the cut bunch of grapes and/or a target weight.

The controller is configured to control the at least one first end effector 120 of the first robotic arm 110 to cut the bunch of grapes based on the determined weight of the bunch of grapes, and the controller is configured to control the at least one second end effector 122 of the second robotic arm 114 to hold and manipulate the cut bunch of grapes into a container.

It will be understood that when it is described that the controller 160 is configured to determine the weight of the bunch of grapes it may be configured to do this from visual inspection alone. Additionally, or alternatively, the controller 160 may be configured to determine the mass of the bunch of grapes from visual inspection alone. In some examples the controller 160 may be configured to determine the type/species of grapes and determine the weight and/or mass of the bunch of grapes based on the determined type/species and an estimated size (e.g. in terms of area and/or volume) of the bunch of grapes. The determination of the type/species may be performed by image recognition, for example using a pre-trained machine learning algorithm. The determination/estimation of the size may be performed, for example, using a point cloud analysis, semantic image segmentation and/or instance segmentation.

In examples where the at least one second end effector 122 comprises a pressure sensing assembly, the controller may be configured to control the at least one second end effector 122 of the second robotic arm 114 to hold and manipulate the cut bunch of grapes into a container 142 based on an indication of the contact pressure.

In some examples the controller may have already packed a cut bunch of grapes into a container 142, but the container 142 is still below a target weight. In such examples the controller may be configured to cut a new bunch of grapes based on the difference between the target weight and the bunch of grapes already placed in the container 142. For example, the controller may determine a difference weight and may be configured to control the first robotic arm 110 and the at least one first end effector 120 to cut the bunch of grapes to obtain a cut bunch of grapes having a weight approximately equal to the difference weight. The first conveyor 130 may then transport this cut bunch of grapes having a weight approximately equal to the difference weight to a region proximate to the second robotic arm 114, where the at least one second end effector holds and manipulates the cut bunch of grapes and places or packs it into the container 142 that already has the previously cut bunch of grapes inside. In this way, the system 100 may be configured to pack containers 142 with grapes to reach a target weight or weight range.

The controller may also be configured to control the first conveyor 130 based on operation of the first robotic arm 110 and/or the second robotic arm 114. The controller may be configured to control the first conveyor 130 based on control of at least one of the at least one first end effector 120 of the first robotic arm 110 and/or the at least one second end effector 122 of second robotic arm 114. For example, the controller may be configured to control the first conveyor 130 in response to the at least one first end effector 120 of the first robotic arm 110 cutting a bunch of grapes. For example, as the bunch of grapes is being cut, the controller 160 may be configured to control operation of the first conveyor 130 to separate the cut bunch of grapes from the remainder of the bunch, to make it easier for the second robotic arm 114/the at least one second end effector 122 to hold and manipulate the cut bunch of grapes. The controller may also be configured to control operation of the optional second conveyor 140, for example based on operation of the second robotic arm 114 and/or when a container has been packed to a predetermined weight or weight range.

The item packing 100 system may comprise an optional manipulating means 121 arranged to manipulate (for example, flip) the bunch of grapes such that a different face of the bunch of grapes is exposed to the at least one camera 155. The manipulating means 121 may comprise a turntable or L-shaped table that is configured to rotate through at least 90 degrees to flip or turn a bunch of grapes over on the first conveyor 130. In some examples the first conveyor 130 may comprise two portions—a first portion one side of the manipulating means 121 and a second portion the other side of the manipulating means 121, such that a bunch of grapes can be delivered onto the manipulating means 121 from the first portion and then the manipulating means 121 flips the bunch of grapes onto the second portion of the conveyor 130. Operation of the conveyor 130 and/or the manipulating means 121 may be controlled by a sensor such as an infra-red sensor 150 located proximate to the first robotic arm 110 that is configured to detect the presence of an object/item such as a bunch of grapes.

The manipulating means 121 may be proximate to the first robotic arm 110 and/or in the field of view of the pair of cameras 155 arranged to view a region of the first conveyor 130 proximate to the first robotic arm 110. The controller 160 may be configured to make a second determination of the weight of the bunch of grapes based on received image data relating to the different exposed face of the flipped bunch of grapes. The controller 160 may be configured to compare the second determined weight of the bunch of grapes with the determined first weight of the bunch of grapes. The controller 160 may then average the two weights to obtain an average determined weight of the bunch of grapes. Additionally, or alternatively, if the difference between the two determined weights is greater than a selected threshold difference, the controller 160 may be configured to control the item packing system to repeat the weight determinations and or to flag an error condition. This may result in the bunch of grapes being rejected and/or requesting intervention from a user/operator of the system. In some examples this may involve the second robotic arm 114 holding and manipulating the bunch of grapes and placing them in a waste bin or container.

In some examples the controller 160 may be configured to perform a visual inspection (as described in more detail below) of the bunch of grapes before and/or after the grapes have been manipulated (e.g. flipped). In some examples the controller 160 may be configured to control the first end effector 120 of the first robotic arm 110 to cut or prune any grapes identified as being defective (for example comprising blemishes). In some examples the controller 160 may be configured to perform this for each side of the bunch of grapes i.e. before and after the bunch of grapes have been flipped by the optional manipulating means 121.

In some examples, such as when the system comprises a depth sensing sensor such as a LiDAR sensor and/or RGB-D camera as discussed in more detail below, the controller 160 is configured to obtain point cloud information. The point cloud information may be used by the controller 160 to determine the weight of the bunch of grapes, for example by determining the size/volume of each grape making up the bunch of grapes, for example by modelling each of the grapes of the bunch. In some examples the controller may also be configured to determine the species/variety of grape based on e.g. image recognition to then determine the weight or mass of the grapes based on both their determined size/volume and their determined species/variety.

In some examples the controller 160 is configured to perform semantic image segmentation on the received image data to determine the location of stems or stalks relative to the grapes of the bunch of grapes, and wherein the controller 160 is configured to use the determined location of stems or stalks to control the at least one first end effector 110 of the first robotic arm 110 to cut the bunch of grapes at a stem or stalk. Additionally, or alternatively, the controller 160 may be configured to determine an orientation to hold the bunch of grapes in based on the received image data. For example, the controller may be configured to determine an orientation to hold the bunch of grapes in based on the determined location of stems or stalks.

In use, bunches of grapes are sequentially fed onto the conveyor 130. The conveyor 130 is controlled by the controller 160 to deliver bunches of grapes to the robotic arms 110, 114. As a bunch of grapes travels along the conveyor 130, it approaches the first infra-red sensor 150 and blocks it, indicating to the controller 160 that the bunch of grapes are in position next to the first robotic arm 110. This stops the conveyor 130, and a visual inspection of the bunch of grapes is performed using the first pair of cameras 155. The controller 160 may then perform instance segmentation (as described in more detail below) on the received image data from the cameras 155 to identify a region of interest and apply a mask to the bunch of grapes within that region of interest. The controller 160 may then determine the weight of the bunch of grapes based on the size of the mask (e.g. based on the number of pixels in the mask). The controller 160 may then make a determination as to whether to cut the bunch of grapes or not depending on the determined weight and a target weight for each container 142, and/or whether any grapes have already been placed in that container 142. If it is determined that the bunch of grapes is to be cut, the controller 160 determines the place to cut the grapes (as will be described in more detail below, but which may be based on a trained semantic segmentation machine learning model). The controller 160 then controls the first robotic arm 110 and the at least one first end effector 120 to cut the bunch of grapes at a stalk/stem to give the desired weight of grapes needed to fill or complete a container 142. For example, if a target weight for each container 142 is 500 g, and there are already grapes weighing 300 g in the container, the controller 160 determines that it needs 200 g more for that container 142 and cuts the bunch of grapes to give a cut bunch of grapes weighing 200 g so that that container can be filled 142 to the desired target weight. It will be understood that the target weight can be set and adjusted by a user for example via a GUI. In some examples the controller 160 may also be configured to determine where within a container 142 a bunch of grapes has been placed, so that if more/another bunch of grapes is to be placed in that same container 142 the additional grapes/bunch may be placed in a different position to more even distribute the placement of grapes within the container 142. In some examples the system may comprise another camera or pair of cameras 155 to perform visual inspection of the containers 142 for this purpose.

Once the bunch has been cut, the controller 160 controls the conveyor 130 to convey the cut bunch of grapes to the second robotic arm 114. Here, the second infra-red sensor 152 detects the presence of the cut bunch of grapes as they approach the second robotic arm 114 and causes the conveyor 130 to stop again with the cut bunch of grapes proximate to the second robotic arm 114. The second pair of cameras 155 then obtain image data and the controller 160 optionally makes a second determination of the weight of the cut bunch of grapes as a validation step. If the second determination of the weight gives an indicated weight that is different to that expected or desired by the controller 160 for placing into the container 142, for example outside of a selected range of that expected (for example the expected weight could be the weight the controller 160 has determined to be remaining once the bunch of grapes was originally cut by the first end effector 120), the bunch of grapes may be discarded or alternatively placed into a different container 142 to that originally intended. If the second determination of the weight indicates a weight within a selected threshold of the first determined weight, the controller controls the second robotic arm and the at least one second end effector 122 to carefully pick up the bunch of grapes, rotate and place them in the container 142 on the second conveyor 140. In some examples a third determination of the weight is obtained once the grapes have been placed in the container 142. For example, the container 142 may be on a weight sensor that can weight the containers 142, for example both before and after grapes have been deposited therein. This third determination of the weight may be used as a cross-check and may be used for example in training the machine learning algorithm operating on the controller 160, for example by way of reinforcement learning.

This process may then be repeated many times for many more bunches of grapes.

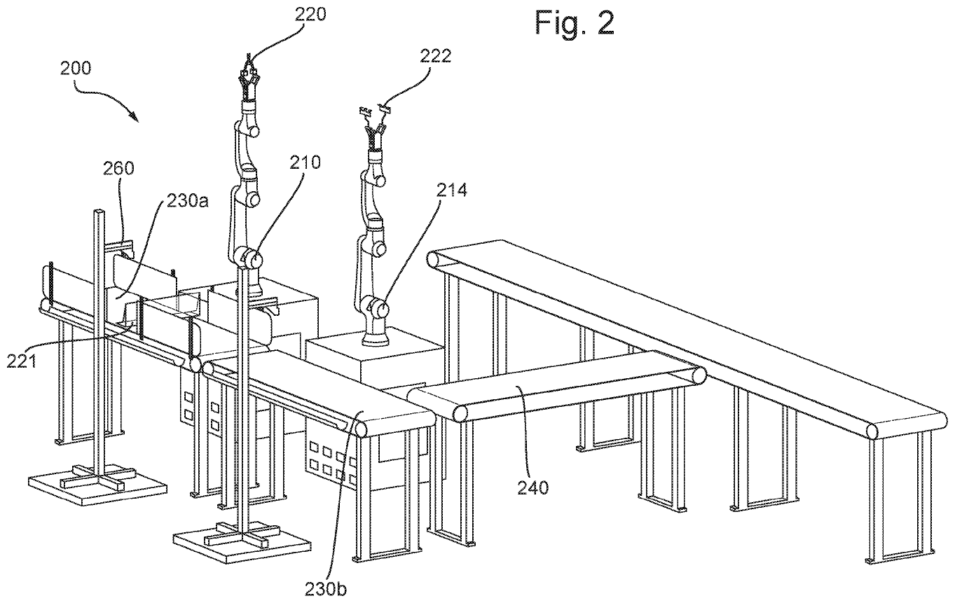

A perspective view of an example of the system 100 of FIG. 1 is shown in FIG. 2. The system 200 shown in FIG. 2 is in many respects very similar to the system 100 shown in FIG. 1, with like reference numerals indicating features with a similar or the same functionality. Unlike the system 100 shown in FIG. 1, however, the first conveyor 130 is replaced by two separate conveyors, 230a and 230b. The two conveyors 230a, 230b may be separated in height, so that the first conveyor 230a (proximate to the first robotic arm 210 is higher than the second conveyor 230b proximate to the second robotic arm 214. The use of two separate conveyors 230a, 230b proximate to the at least one first end effector 220 that is configured to perform the snipping operation may help to separate a snipped or cut bunch of grapes. The separation of a snipped or cut bunch of grapes may be performed in two ways. First, after snipping the snipper (i.e. the at least one end effector 220) may be moved slightly front and back to give a small fine gap. Additionally or alternatively, when two conveyors are used, the controller 160 can control the speeds of the two conveyors 230a, 230b, such that the conveyor 230a in front of the snipping robot (i.e. the first robotic arm 210) is slightly higher than the conveyor 230b in front of the pick & place robot (i.e. the second robotic arm 214). So, due to gravity the grapes will move faster and reach the second conveyor 130b first. If the second conveyor 230b is controlled by the controller 160 to move at a higher speed than the first conveyor 130a, this will make sure these bunches are split.

In some examples there may additionally be cameras placed on the end effectors, such as the on the at least one second end effector 122, 222, to understand the quality of the grasp with the end effector. Gutters may be placed on either side of the conveyors 130a, 130b to make sure any grapes which fell off during operation will be handled properly.

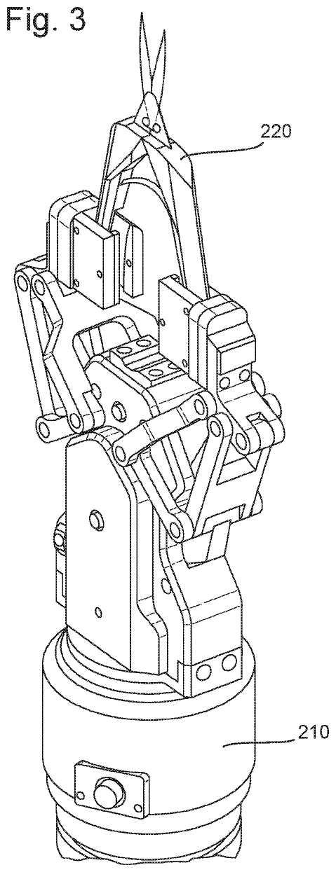

As can be seen in FIG. 2, the at least one first end effector 220 may be a snipping means or cutter such as a pair of scissors or shears. The at least one first end effector 220 is shown in more detail in the perspective view of FIG. 3. The pair of cutters forming the first end effector 220 shown in FIG. 3 comprise a pair of arms having a cutting means at one end and a handle at the other, with a pivot coupling the pair of arms separating the cutting means from the handle. The pair of arms are optionally biased by a leaf spring to remain in an open configuration such that the cutting means are in an open configuration. In the example shown the arms are larger in length than the length of the cutting means, in this instance approximately three times the length. This not only improves the amount of cutting force that may be exerted by the cutters as they are brought together, but also means that the cutting means is relatively small meaning it can be easily inserted among other objects proximate to a location where a cut is to be made. The first end effector 220 is configured to move the handles of the cutter to move the cutters between the open configuration to a closed configuration by bringing the arms of the cutter together, thereby bringing the pair of cutting means together and thereby cutting any object located between them as they are brought together. Once an object has been cut, the first end effector is configured to move or withdraw the handles of the cutters back from the closed configuration to the open configuration (aided in this instance by the optional biasing means) such that the cutting means are separated and in the open configuration, ready to receive an object (such as a stalk or stem of a bunch of grapes) to be cut. Advantageously it has been found that the use of cutting means of this fashion that is relatively small and pointed means the cutting means can advantageously be inserted into a bunch of grapes and manoeuvred into position between grapes to cut a stalk or stem located therebetween.

To operate and move each arm of the cutter, the first end effector 220 comprises fastening means configured to attach to and secure each arm of the cutter. The first end effector 220 further comprises an actuated cantilevered mechanism that is operable to move the fastening means in a slightly arcuate manner to bring the arms together and apart from each to perform the cutting action.

As can also be seen in FIG. 2, the at least one second end effector 222 may be configured to scoop or collect a bunch of grapes. In the example shown in FIG. 2, the at least one second end effector 222 comprises a pair of opposing scoops. This is shown in more detail in FIG. 4. FIG. 4 shows the at least one second end effector 222 comprising a pair of identical opposing scoops coupled by a connecting portion 490 that is configured to be controlled by the controller 160 to control or adjust the separation between the two scoops (it will be understood that the connecting portion 490 used for the second end effector 222 may be the same as the connecting portion used for the first end effector 220, which may improve interoperability of the robotic arms 210, 214 and reduce maintenance and manufacturing costs). Each scoop comprises a plurality (in this example, three) finger portions or digits 480. Each finger portion or digit 480 may comprise a respective pressure sensing means 485, as will be described in more detail below. The pressure sensing means 485 are arranged to detect the amount of force being applied during the grasp on the fruits to grasp, which is particularly important when dealing with irregular-shaped fruits such as grapes when it is important to understand how to grasp to avoid the fruits slipping from the end effector 222.

The scoop mechanism of the at least one second end effector 222 is designed for handling the fruits carefully without causing any damage. Because in the example shown there are six finger portions or digits 480, each will give different reaction forces at different contact regions. Based on the reaction force on each sensor on fingers, the approximate shape of the fruits can be determined (e.g. by the controller 160). The controller 160 may be configured to apply the required force to hold the grapes without damaging fruits irrespective of their shape. The advantage of this scoop mechanism is the number of fingers, the length of the fingertips can be modified based on the fruit type and can give a very high range of picking grapes of width up to 160 mm.

Each finger portion or digit 480 terminates in a curved fingertip 487. The fingertips 487 are designed with an extrusion which will act as the support, and also makes sure that the fruits will not come out during their movement from picking position to placing position. In some examples the pressure sensing means 485 may also be attached to the fingertips 487 which can help to understand if there's any slip during their transfer from picking to placing position based on which we can regulate the speed of the robot and how quickly the system operates. Regulating the speed of robots may help to reduce damage and help reduce grapes falling out during the movement. The length of the extrusion forming each fingertip 487 can be controlled based on the average reaction force needed for the bunches of grapes to be processed which will counter force for the weight of the grapes.

The uniqueness of the design of the scoop is based on the realisation that not all the grapes of a bunch will be resting on a conveyor prior to them being handled, in fact there are actually very few grapes that will normally be resting on a surface such as the conveyor 130 when the grapes are placed on that surface. In some examples, the controller 160 may be configured, based on captured image data e.g. from cameras 160, to estimate at least one of the contact area and/or the orientation of the grapes and thereby the optimal orientation of the at least one second end effector 122, 222 based on the shape of the grapes. This estimation may be used by the controller 160 to determine, for example, the orientation of the least one second end effector 122, 22 and/or to what degree the at least one second end effector 122, 222 may be closed while still ensuring that the grapes are being supported by the end effector and resting on the fingertips 487. It will be appreciated that the design of the scoop and the use of the fingertips 487 means that the fingertips 487 can get underneath the grapes which are just above the grapes resting on the conveyor 130. As soon as the grapes are picked from the conveyor 130, gravity will try to pull the grapes down but the reaction forces of the fingertips 487 at the different locations will make sure the grapes being lifted are very stable. Once they are lifted up based on a determination as to whether the grapes are slipping or not (as will be described in more detail below), the controller 160 may be configured to further open or close the end effector 122, 222 to get the most stable state inside the scoop to move the bunch of grapes from the conveyor 130 to a container 142.

As noted above, the controller 160 may be configured to obtain point cloud information and/or perform semantic image segmentation. In some examples, the controller 160 may be configured to perform both object detection and semantic segmentation to perform instance segmentation. Instance segmentation is challenging because it requires the correct detection of all objects in an image while also precisely segmenting each instance. It therefore combines elements from the classical computer vision tasks of object detection, where the goal is to classify individual objects and localize each using a bounding box, and semantic segmentation, where the goal is to classify each pixel into a fixed set of categories without differentiating object instances.

The object detection may be performed using an Objection Detection API, such as TensorFlow® Object Detection API which is an open source framework built on top of TensorFlow® that makes it easy to construct, train and deploy object detection models. A convolutional neural network library may be used to provide an object detection model. The objection detection model may be run to provide real-time detection and localization of grapes to facilitate the manipulation of the grapes. Preferably, the model used for this task is a fully convolutional detector type model such as You only look once (YOLO) (for example as described in Redmon et al. “YOLO9000: Better, Faster, Stronger, 25 Dec. 2016, https://arxiv.org/pdf/1612.08242v1.pdf) and/or SSD: Single Shot MultiBox Detector (for example as described in Liu et al. “SSD: Single Shot MultiBox Detector” 29 Dec. 2016, https://arxiv.org/pdf/1512.02325.pdf). In addition to object detection, a model to predict segmentation masks on each Region of Interest (Rol) may be used to predict the pixels where the grapes are located. This may be fed into other algorithms such as the weight estimation algorithm and pick and place pipeline.

The cameras 160 used may be RGB-D cameras, which are a specific type of depth sensing devices that work in association with a RGB camera, that are able to augment the conventional image with depth information (related with the distance to the sensor) in a per-pixel basis. The cameras 160 may provide multiple sensors that provide unique streams of information in addition to processed data formats such as a pointcloud stream.

For example, the cameras 160 may be operable to have a colour image stream of RGB frames of up to 1920×1080 pixels in resolution at 30 frames per second, and a depth image stream (the ability to measure the distance (i.e. “range” or “depth”) to any given point in a scene and which distinguishes a depth camera from a conventional 2D camera. This stream provides the depth measurement of each pixel in the frame of the depth sensor. The field of view (FOV) of the depth sensor and colour sensor differ. The cameras 160 may also have an infrared image stream and a pointcloud stream. A pointcloud is a set of data points in space. The points represent a 3D shape or object. Each point has its set of X, Y and Z coordinates. A textured pointcloud has the extra layer of a texture added to the 3D information. In examples of the disclosure, the texture being used is the texture from a colour image sensor. This feature provides a data structure with detailed information to describe a 3-dimensional object.

However, it will be understood that in some examples, for example for more accurate depth analysis, a LiDAR camera such as a RealSense™ LiDAR camera may be used additionally or alternatively, which may bring an additional level of precision and accuracy over its entire operational range. In the scenario of cutting the stems off the bunches of grapes a high level of accuracy is needed to make surgical-like cuts to the stems. These LiDAR cameras are able to provide an accuracy up to −5 mm error rate.

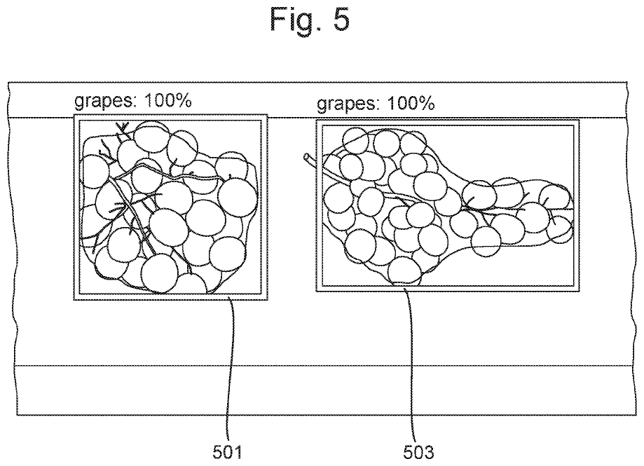

An example output of the image processing performed by the controller 160 is shown in FIG. 5, which can identify the regions of each image occupied by respective bunches of grapes 501, 503 and can define a mask within a region of interest. The mask may represent the area bounded by the bunch of grapes and may be used by the controller 160 to estimate the weight of the bunch of grapes. This mask may also be used by the controller 160 to control the orientation of the at least one second effector 222 of the second robotic arm 214 for grasping the bunch of grapes, for example so that the at least one second end effector 222 is in the optimal orientation to pick up the bunch of grapes.

As noted above, the controller 160 is configured to determine the weight of a bunch of grapes using obtained image data. This may be performed as follows.

First, an instance segmentation model is run on image data obtained from the cameras 155, which may for example be colour depth cameras such as Realsense™ depth cameras. An ObjectslnMasks message may be output which represents a detected object and its region of interest. The following attributes are contained in the message:

Header: Contains the timestamp and the coordinate frame this data is associated with.

This would be the coordinate frame of the optical sensor of the camera
Objects vector: This is an array of objects that have been detected. Contain the following attributes
Object name: The name of the detected object. For example red_grapes
Probability: The confidence of the detection output in percentage of object.
Region of interest: Defines the x and y coordinate offsets and width and height of particular objects location in the camera frame
Mask: Defines a mask within the region of interest where the pixels of the detected object is predicted to be (as shown in FIG. 5).

As noted above, the controller 160 may perform weight estimation to estimate the weight of grapes using data obtained from the cameras 155. This is achieved by two approaches. First, the weight may be estimated using the instance mask (as shown in FIG. 5). The number of pixels in the mask may be correlated to the weight of the bunch using a number of samples. To be able to achieve this, linear regression may be used to model the relationship between a scalar value-weight, and one explanatory variable—number of pixels. Second, weight may be estimated from 3D Pointcloud data. This approach may use 3D pointcloud data. Some depth sensors may only obtain an unstructured point cloud. To get a triangle mesh from this unstructured input surface reconstruction may be performed. This may involve processing the 3D pointcloud data to filter out the mesh of the grapes using algorithms for generating 3D geometry, i.e., a triangle mesh in combination with plane segmentation methods and segmentation using the mask from the instance segmentation node, calculate the approximate volume of the filtered mesh containing points belonging to the grapes under review, and then calculate the weight of the bunch of grapes using an approximate density previously calculated through experimentation.

As noted above, as part of the process for handling and packing grapes there is a step where the bunches of grapes may be cut and divided into smaller portions to be packed into a punnet or container 142. This involves a procedure for identifying the location of the stems in 3D space.

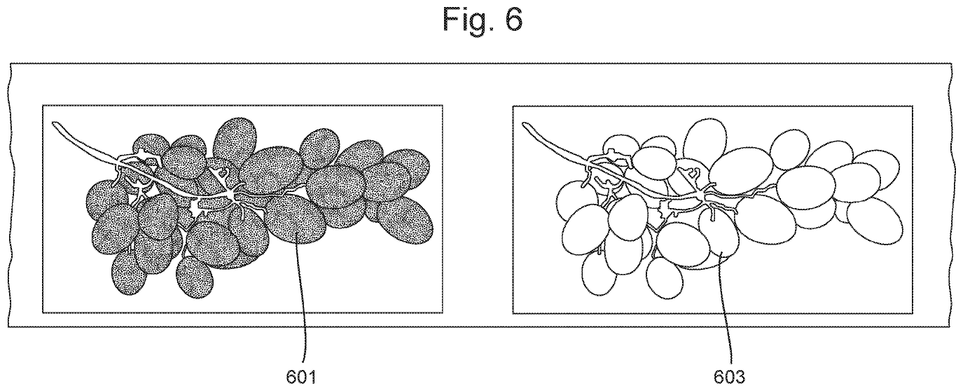

For the purpose of detecting the location of stems, a semantic segmentation model is trained on images of grapes based on a dataset created and annotated to label the pixels where the stems are located in the camera frame. An example of this is shown in FIG. 6, showing a first image 601 of a bunch of grapes and a second image 603 of an annotated bunch of grapes labelling the pixels where the stems are located. A model used for this process may be the DeepLabV3 plus architecture with an Xception65 backbone for feature extraction.

The detected points may be sampled and scored based on the location of the detected points and the probability of the point being a main branch to produce a split in the network of stems. After the point is selected, it may then be transformed into real world coordinates using, for example, calibration data obtained from a hand-eye calibration step.

FIG. 7 shows a schematic diagram of another exemplary system for sorting and/or packing items such as grapes in plan view. The system shown in FIG. 7 shares many features in common with that described above with reference to FIGS. 1 and 2, with like reference numerals denoting features with similar or the same functionality. It will be understood that aspects of the system described with reference to FIG. 7 could be removed, replaced or combined with those described above with reference to FIGS. 1 and 2.

In the example shown in FIG. 7, the system is an item packing apparatus or system 700 adapted for picking grapes. However, it will be understood that the item picking apparatus or system 700 of FIG. 7 may be adapted for use with other non-linear objects, such as other non-linear fruits and vegetables, such as bunches of bananas or other vine fruits or vegetables such as tomatoes.

The system 700 comprises a first robotic arm 710 comprising at least one first end effector 170 for cutting grapes from a bunch. The at least one first end effector 720 may comprise a cutting means for cutting grapes from a bunch, for example the first end effector 720 may be the end effector shown in FIG. 3 as described above.

The system 700 also comprises a second robotic arm 714 spaced from the first robotic arm 110. The second robotic arm 714 comprises at least one second end effector 722 for holding and manipulating a bunch of grapes for packing into a container 742. The at least one second end effector 722 may be the end effector shown in FIG. 4 as described above, or as shown in FIG. 8 as described in more detail below.

The first and second robotic arms 710, 714 are provided on respective movable platforms 712, 716. The fact that they are movable may mean that they can be taken out of the way if the task is to be performed manually. The movable platforms 712, 716 may each comprise a controller such as a local controller for controlling each robotic arm 710, 714 and its respective end effectors 720, 722.

The system 700 further comprises a plurality of conveyors for conveying bunches of grapes past each robotic arm 710, 714. In the example shown in FIG. 7, a first conveyor 728 is located proximate and to one side of the first robotic arm 710. The first conveyor 728 is arranged to convey grapes onto a second conveyor 730a also proximate to the first robotic arm 710. The second conveyor 730a is transverse to the first conveyor 730a and in this example is offset in height relative to the first conveyor 728 such that the second conveyor 730a is lower than the second conveyor. The second conveyor 730a is arranged to convey grapes from the second conveyor 730a to a third conveyor 730b. The third conveyor 730b is parallel to the second conveyor 730a and in this example is offset in height relative to the second conveyor 730a such that the third conveyor 730b is lower than the second conveyor. The third conveyor 730b is proximate to and to one side of the second robotic arm 714. A fourth conveyor 740 is provided also proximate to and to one side of the second robotic arm 714, and is transverse to the third conveyor 730b.

In the example shown in FIG. 1, the system 700 further comprises four cameras 755a-d arranged to view a region of each conveyor 728, 730a, 730b, 740 proximate to where each robotic arm 710, 714 may operate. In this example each camera is a 3D/depth sensing RGB-D camera as discussed above, although it will be understood that any one of the cameras may be replaced or supplemented with a light detection and ranging, LIDAR, apparatus.

The system 700 also comprises a controller 760 which may have similar or the same functionality as the controller 160 described above. The controller 760 may comprise a data store 764, processor 766 and a communications interface 768. The controller 760 may additionally or alternatively include a graphical user interface, GUI (not shown). In some examples the functionality of the controller may be provided by a (local) controller mounted in the movable platform 712, 716 of one of the robotic arms 710, 714, for example such that one (local) controller is configured to act as a “master” controller and the other controller is configured to act as a “slave” controller.

In the example shown in FIG. 7 the item packing 700 system comprises two optional manipulating means 721a, b arranged to manipulate (for example, flip) the bunch of grapes, for example such that a different face of the bunch of grapes is exposed to the first camera 755a or so the orientation of the bunch of grapes is adjusted so that when the grapes are manipulated by the second robotic arm 714 for placement in the container 742 the bunch are in an orientation where the stalk is facing down into the container 742. The manipulating means 721a, b may comprise a turntable or L-shaped table that is configured to rotate through at least 90 degrees to flip or turn a bunch of grapes over. In the example shown the system 700 comprises a first manipulating means 721a proximate to the first robotic arm 710, and a second manipulating means 721b proximate to the second robotic arm 714. In some examples the manipulating means 721a, 721b may be located at an end of the conveyor, for example such that the first manipulating means 721a is at the end of the first conveyor 728. Operation of the manipulating means 721a, b may be controlled by a sensor such as an infra-red sensor 752a-d as described below that is configured to detect the presence of an object/item such as a bunch of grapes.

In some examples the controller 760 may be configured to perform a visual inspection (as described in more detail below), for example using camera 755a, of the bunch of grapes before and/or after the grapes have been manipulated (e.g. flipped). In some examples the controller 760 may be configured to control the first end effector 720 of the first robotic arm 710 to cut or prune any grapes identified as being defective (for example comprising blemishes). In some examples the controller 760 may be configured to perform this for each side of the bunch of grapes i.e. before and after the bunch of grapes have been flipped by the optional manipulating means 721. In some examples the controller 760 may be configured to perform a weight determination of the bunch of grapes before and/or after manipulating by the first manipulating means 721a. This weight determination may be combined or compared with any later weight determination performed by the controller 760 as discussed below, for example to improve quality control.

In the example shown in FIG. 7 there is a respective light gate which in this case is a second and a third infra-red sensor 752b, c proximate to each robotic arm 710, 714. There is also a first infra-red sensor 752a proximate to the optional manipulating means 721a and a fourth infra-red sensor 752d for detecting the presence of containers 742 on the fourth conveyor 740.

The infra-red sensors 752a-d are configured to determine the presence of an object/item on a conveyor 728, 730a, 730b, 740 proximate to each robotic arm 710, 714. The controller may be configured to use sensor inputs from each infra-red sensor 752a-d to control operation of each robotic arm 710, 714 and/or control operation of the respective conveyor 728, 730a, 730b, 640. Although an infra-red sensor is described, other types of sensors configured to determine the presence of an object/item such as a bunch of grapes may be used. For example, a conveyor 728, 730a, 730b, 740 may comprise pressure sensors underneath configured to detect the presence of an object/item on the conveyor 130.

In some examples the fourth conveyor 740 may comprise a weight sensor configured to determine the weight of a container 742 and/or fruit such as a cut bunch of grapes 733 placed in them. In some examples the weight sensor may serve as a validation tool for the vision weight estimation algorithm employed by the controller 760. It will be understood that the data obtained from the weight sensor may be used to improve the machine learning, for example via reinforcement. In some examples if the determination of the weight from the weight sensor differs from the expected weight (for example the weight determined by the controller 760 by visual inspection with the cameras 755a-d) by more than a selected threshold, this may result in the container 742 being discarded and/or a notification being sent indicating that manual inspection of the container 742 is required. For example, if the determination of the weight from the weight sensor differs from the expected weight (for example the weight determined by the controller 760 by visual inspection with the cameras 755b adjacent to the first robotic arm 710 and/or the camera 755a adjacent to the first manipulating means 721a) by more than a selected threshold, the controller 760 may flag an error condition. This may result in the bunch of grapes being rejected and/or requesting intervention from a user/operator of the system. In some examples this may involve the second robotic arm 714 holding and manipulating the bunch of grapes and placing them in a waste bin or container

As with the examples of FIGS. 1, 2 and 4, the at least one second end effector 722 may comprise a pressure sensing assembly for providing an indication of a contact pressure. The pressure sensing assembly may comprise a pressure sensing assembly (as described in more detail with reference to FIGS. 4 and 8). The pressure sensing assembly may comprise: (i) a plurality of piezoresistive sensors each configured to obtain piezoresistive signals; and (ii) a plurality of piezoelectric sensors each configured to obtain piezoelectric signals, thereby to provide the pressure sensing assembly. In some examples the at least one second end effector 722 may comprise a pair or more of end effectors for determining a contact pressure of an item/bunch of grapes held there between. In some examples the at least one second end effector 722 may comprise a scoop or a scooped portion (as shown in FIGS. 4 and 8) for supporting the underside of a bunch of grapes when held and manipulated by the at least one second end effector 722. The scoop or scooped portion may comprise a plurality of digits, and each digit may comprise a portion with an electronic skin.

The cameras 755a-d are arranged to provide image data of the bunch of grapes travelling on the conveyors 728, 730a, 730b, 740.

The controller 760 is configured to receive image data of the bunch of grapes from any of the cameras 755a-d and to make a determination of the weight of the bunch of grapes based on the received image data. This may be using image data obtained from the second camera 755b adjacent to the first robotic arm 710, and/or from any of the other cameras 755a-d to obtain further weight determinations that may, for example, be compared to each other by the controller 760 as part of a cross-check or validation process to help ensure quality control.

The controller 760 may be configured to receive image data of a bunch of grapes to be cut from the second camera 755b proximate to the first robotic arm 710, and/or the controller 760 may also be configured to receive image data of a cut bunch of grapes from the third camera 755c proximate to the second robotic arm 714 and to make a determination of the weight of the cut bunch of grapes based on the received image data from the second camera 755c proximate to the second robotic arm 714. The controller 760 may be configured to make a determination as to whether to pack the cut bunch of grapes into a container 742 based on the determined weight of the cut bunch of grapes. In some examples the controller 760 may be configured to determine which container 742 to pack the cut bunch of grapes into or select a container 742 from a plurality of containers 742 to pack the cut bunch of grapes in to based on the determined weight of the cut bunch of grapes and/or a target weight.

The controller 760 is configured to control the at least one first end effector 720 of the first robotic arm 710 to cut the bunch of grapes based on the determined weight of the bunch of grapes, and the controller 760 is configured to control the at least one second end effector 722 of the second robotic arm 714 to hold and manipulate the cut bunch of grapes into a container 742.

As described above with reference to the examples of FIGS. 1 and 2, it will be understood that when it is described that the controller 760 is configured to determine the weight of the bunch of grapes it may be configured to do this from visual inspection alone. Additionally, or alternatively, the controller 160 may be configured to determine the mass of the bunch of grapes from visual inspection alone. In some examples the controller 760 may be configured to determine the type/species of grapes and determine the weight and/or mass of the bunch of grapes based on the determined type/species and an estimated size (e.g. in terms of area and/or volume) of the bunch of grapes. The determination of the type/species may be performed by image recognition, for example using a pre-trained machine learning algorithm. The determination/estimation of the size may be performed, for example, using a point cloud analysis, semantic image segmentation and/or instance segmentation.

In examples where the at least one second end effector 722 comprises a pressure sensing assembly, the controller may be configured to control the at least one second end effector 722 of the second robotic arm 714 to hold and manipulate the cut bunch of grapes into a container 742 based on an indication of the contact pressure.

As with the examples described above, the controller 760 may have already packed a cut bunch of grapes into a container 742, but the container 742 is still below a target weight. In such examples the controller 760 may be configured to cut a new bunch of grapes based on the difference between the target weight and the bunch of grapes already placed in the container 742. For example, the controller 760 may determine a difference weight and may be configured to control the first robotic arm 710 and the at least one first end effector 720 to cut the bunch of grapes to obtain a cut bunch of grapes having a weight approximately equal to the difference weight. The first conveyor 730 may then transport this cut bunch of grapes having a weight approximately equal to the difference weight to a region proximate to the second robotic arm 714, where the at least one second end effector holds and manipulates the cut bunch of grapes and places or packs it into the container 742 that already has the previously cut bunch of grapes inside. In this way, the system 700 may be configured to pack containers 742 with grapes to reach a target weight or weight range.

The controller may also be configured to control any of the conveyors 728, 730a, 730b, 740 based on operation of the first robotic arm 710 and/or the second robotic arm 714. The controller may be configured to control the first conveyor 728 and/or the second conveyor 730a based on control of at least one of the at least one first end effector 720 of the first robotic arm 710 and/or the at least one second end effector 722 of second robotic arm 714.

In use, bunches of grapes 732 are sequentially fed onto the first conveyor 728. The conveyor 728 is controlled by the controller 760 to deliver bunches of grapes to the robotic arms 710, 714. As a bunch of grapes 732 travels along the first conveyor 728, it approaches the first infra-red sensor 752a and blocks it, indicating to the controller 760 that the bunch of grapes are in position next to the first manipulating means 721a. This stops the conveyor 728, and a visual inspection of the bunch of grapes is performed using the first camera 755a. The controller 760 may then perform instance segmentation (as described in more detail below) on the received image data from the first camera 755a to identify a region of interest and apply a mask to the bunch of grapes 732 within that region of interest. The controller 760 may then optionally determine the weight of the bunch of grapes based on the size of the mask (e.g. based on the number of pixels in the mask). The controller 760 may additionally or alternatively perform a visual inspection of the bunch of grapes 732 to determine if there are any blemishes/defects. If a blemish or defect is detected, the controller 760 may determine that a grape or grapes from the bunch should be removed, and may control the at least one first end effector 720 of the first robotic arm to cut off the affected grapes from the bunch. Additionally, or alternatively, the entire bunch 732 may be discarded if there is a number of grapes having blemishes or defects greater than a selected threshold. In such circumstances an additional manipulating means (not shown) may be operated to remove the bunch of grapes 732, for example by pushing the bunch of grapes 732 off of the conveyor 728. It will also be understood that the additional manipulating means may also push the bunch of grapes 732 off of the second conveyor 730a.

Once a first visual inspection of the bunch of grapes has been performed, the controller 760 controls the first manipulating means 721a to rotate (flip) the bunch of grapes 732 over so that visual inspection of the other side of the bunch can be performed. Again, If a blemish or defect is detected, the controller 760 may determine that a grape or grapes from the bunch should be removed, and may control the at least one first end effector 720 of the first robotic arm to cut off the affected grapes from the bunch. Additionally, or alternatively, the entire bunch 732 may be discarded if there is a number of grapes having blemishes or defects greater than a selected threshold. It will also be understood that the controller 760 may also optionally determine the weight of the bunch of grapes based on the size of the mask (e.g. based on the number of pixels in the mask). This second weight determination may be compared to the first weight determination, for example to obtain an average weight determination. Additionally, or alternatively, if there is a difference greater than a selected threshold difference between the two weight determinations, an error flag may be raised, for example perhaps necessitating intervention by a user.

Once inspect of both sides of the bunch 732 has been performed, the controller 760 then controls the first conveyor 728 to convey the bunch of grapes to the second conveyor 730a. The second conveyor 730a then conveys the bunch of grapes to the second infra-red sensor 752b whereby the controller 760 stops the second conveyor 730a. This stops the conveyor 730a, and a visual inspection of the bunch of grapes is performed using the second camera 755b. The controller 760 may then perform instance segmentation (as described in more detail below) on the received image data from the second camera 755b to identify a region of interest and apply a mask to the bunch of grapes 732 within that region of interest. The controller 760 may then optionally determine the weight of the bunch of grapes based on the size of the mask (e.g. based on the number of pixels in the mask). The controller 760 may additionally or alternatively perform a visual inspection of the bunch of grapes 732 to determine if there are any blemishes/defects. The controller 760 may then make a determination as to whether to cut the bunch of grapes or not depending on the determined weight and a target weight for each container 742, and/or whether any grapes have already been placed in that container 742. If it is determined that the bunch of grapes is to be cut, the controller 760 determines the place to cut the grapes (as will be described in more detail below, but which may be based on a trained semantic segmentation machine learning model). The controller 760 then controls the first robotic arm 710 and the at least one first end effector 720 to cut the bunch of grapes at a stalk/stem to give the desired weight of grapes needed to fill or complete a container 742. For example, if a target weight for each container 142 is 500 g, and there are already grapes weighing 300 g in the container, the controller 160 determines that it needs 200 g more for that container 742 and cuts the bunch of grapes to give a cut bunch of grapes weighing 200 g so that that container can be filled 742 to the desired target weight. It will be understood that the target weight can be set and adjusted by a user for example via a GUI.

Once the bunch has been cut, the controller 760 controls the second and third conveyors 730a, 730b to convey the cut bunch of grapes 733 to the second robotic arm 714. Because the third conveyor 730b is travelling more quickly than the second conveyor 730a, the cut bunch of grapes are separated from each other to make manipulation of the cut bunch of grapes 733 by the at least one second end effector 722 easier. Here, the third infra-red sensor 752c detects the presence of the cut bunch of grapes as they approach the second robotic arm 714 and causes the third conveyor 730b to stop again with the cut bunch of grapes 733 proximate to the second robotic arm 114. The third camera 755c then obtains image data and the controller 760 optionally makes another determination of the weight of the cut bunch of grapes as a validation step. If this determination of the weight gives an indicated weight that is different to that expected or desired by the controller 760 for placing into the container 742, for example outside of a selected range of that expected (for example the expected weight could be the weight the controller 760 has determined to be remaining once the bunch of grapes 732 was originally cut by the first end effector 720), the bunch of grapes 733 may be discarded or alternatively placed into a different container 742 to that originally intended. If the determination of the weight indicates a weight within a selected threshold of the first determined weight, the controller 760 controls the second robotic arm 714 and the at least one second end effector 722 to carefully pick up the bunch of grapes 733, rotate and place them in the container 742 on the fourth conveyor 740.

As noted above, image processing may be performed to define a mask within a region of interest. The mask may represent the area bounded by the bunch of grapes and may be used by the controller 760 to estimate the weight of the bunch of grapes. This mask may also be used by the controller 760 to control the orientation of the at least one second effector 222 of the second robotic arm 714 for grasping the bunch of grapes, for example so that the at least one second end effector 722 is in the optimal orientation to pick up the bunch of grapes.

The output of the instance segmentation model performed by controller 160 may include a mask of predicted pixels for the grape bunches. A computer vision algorithm may then be run that finds a rotated rectangle of the minimum area enclosing the input 2D point set. The function calculates and returns the minimum-area bounding rotated rectangle for a specified point set. The angle of this rectangle may then be transformed to the frame of the second end effector 722 through transformation calculations within the robotic system to determine the corresponding angle the second end effector 722 would need to be rotated. This may advantageously allow the send end effector 722 to have the optimal orientation to manipulate a cut bunch of grapes 133.

In some examples, the controller 760 may also be configured to control the second optional manipulating means 721b to alter the orientation of or flip the cut bunch of grapes 733. This may be so that the bunch of grapes are stalk-side down, so that when they are manipulated by the second end effector 722 placed in the container 742 they are placed with their stalk down, which may be more aesthetically pleasing to a consumer.

In some examples a third determination of the weight is obtained once the grapes have been placed in the container 742. For example, the container 142 may be on a weight sensor that can weight the containers 142, for example both before and after grapes have been deposited therein. This third determination of the weight may be used as a cross-check and may be used for example in training the machine learning algorithm operating on the controller 160, for example by way of reinforcement learning.

The controller 760 may also be configured to determine where within a container 742 a bunch of grapes has been placed using image data obtained from the fourth camera 755d, so that if more/another bunch of grapes is to be placed in that same container 742 the additional grapes/bunch may be placed in a different position to more evenly distribute the placement of grapes within the container 742.

This process may then be repeated many times for many more bunches of grapes.

FIGS. 8A to 8D show views of another example end effector 800 for grasping, holding and/or manipulating vine fruit such as a bunch of grapes. As can be seen, the end effector 800 of FIGS. 8A to 8D is in many respects similar to the end effector described above with reference to FIG. 4, and it will be appreciated that the end effector of FIGS. 8A to 8D may have the same or similar functionality to the end effector of FIG. 4, with like reference numbers indicating features with the same or similar functionality.

FIG. 8A shows an inside view of the scoop attachment of the end effector 800, FIG. 8B shows an outside view of the scoop attachment of the end effector 800, FIG. 8C shows a top view of the fingertips 807 (in this example eight fingertips) of the end effector 800, and FIG. 8D shows an isometric view of the scoop attachment of the end effector 800. The scoop attachment of the end effector 800 shown in FIGS. 8A to 8D is one half of the end effector 800; it will be understood that a pair of opposing scoops will be used to form the end effector 800. A connection portion may be used to couple to two opposing scoops much in the way described above in relation to FIG. 4. In the example shown in FIGS. 8A to 8D, instead of a plurality of fingers or digits 480 as shown in FIG. 4, the scoop comprises a central palm portion 810 comprising a plurality (in this example, four) pressure sensing regions 885. Coupled to the central palm portion 810 are a plurality of curved fingertips 887 (in this example, eight). The fingertips 887 are designed to be resiliently deformable to softly pick up the fruit so that it does not fall out but are deformable so as to avoid exerting too much pressure on the fruit so as to bruise or damage it. The curvature of the fingertips 887 are selected to aid in getting under the fruit such as a bunch of grapes as the two opposing scoops are brought together to prevent any loose grapes from falling out of the bunch. Having a plurality of fingertips 887 is advantageous in that each fingertip is able to bend and deform independently of the other fingertips 887. This enables the end effector to grasp the grapes in order to deal with the most complex shapes of grapes. The fingertips 887, like humans, adopt the shape of the grapes easily. Another important feature of the of the design of the end effector 800 shown in FIGS. 8A to 8D is the ability to return or to get back to the same shape after finishing the pick and place cycle. There will be very less recovery time to get back to its shape because of the shape used.

In the example shown in FIGS. 8A to 8D there is only a sensing means on the palm portion 810 of the end effector 800 and not on each fingertip 887. However, it will be understood that in other examples there may additionally or alternatively be a sensing means on some of or all of the fingertips 887. In the example shown in FIGS. 8A to 8D there are also less sensing regions 885 than there are fingertips 887, however in other examples the palm portion 810 may comprise more sensing portions 885 or the same number of sensing portions as there are fingertips 887.

Many robotic applications depend on vision to perceive the world and plan robot motions. But without knowing where the camera is in relation to the robot, any spatial information extracted from the camera is useless. Extrinsic calibration is the process to determine the camera's pose. A calibration target is generated that is printed and mounted on a flat surface on the end-effector. Measurement of the target's size is necessary, although the target's location and orientation do not need to be measured—instead, several observations of the target allow the calibration to be computed independent of the target's precise location.

When calibrating, a calibration target attached to one of the robot links, which is known as “eye-to-hand” calibration, the camera is placed statically in the scene, allowing for easy computation of the target motion. The dataset required for calibration consists of the camera-to-target transform paired with the base-link-to-end-effector transform. The robot kinematics provide the end-effector's pose in the robot base frame, and the calibration target's pose in the camera frame can be estimated, as mentioned above. If the target's pose in the robot base frame were known accurately, only a single observation of the camera-target transform would be necessary to recover the camera's pose in the end-effector frame. The direct camera-to-end-effector transform is equivalent to the composite camera-to-target-to-base-link-to-end-effector transform. A better option, however, is to combine the information from several poses to eliminate the target pose in the base frame from the equation. At least five pose pairs are necessary to compute a calibration, and typically the calibration gets more accurate as more pose pairs are collected up to about 15 pairs.

For more information on the mathematical methods used in Movelt Calibration to solve for a calibration, see Daniilidis, 1999¹, Park and Martin, 1994², and Tsai and Lenz, 1989³.

There are various types of calibration boards that may be used for hand-eye calibration. For example, Chessboard, Asymmetric circles, Aruco, and ChAruco. ArUco markers and boards are very useful due to their fast detection and their versatility. However, one of the problems of ArUco markers is that the accuracy of their corner positions is not too high, even after applying subpixel refinement.

On the contrary, the corners of chessboard patterns can be refined more accurately since each corner is surrounded by two black squares. However, finding a chessboard pattern is not as versatile as finding an ArUco board: it has to be completely visible, and occlusions are not permitted.

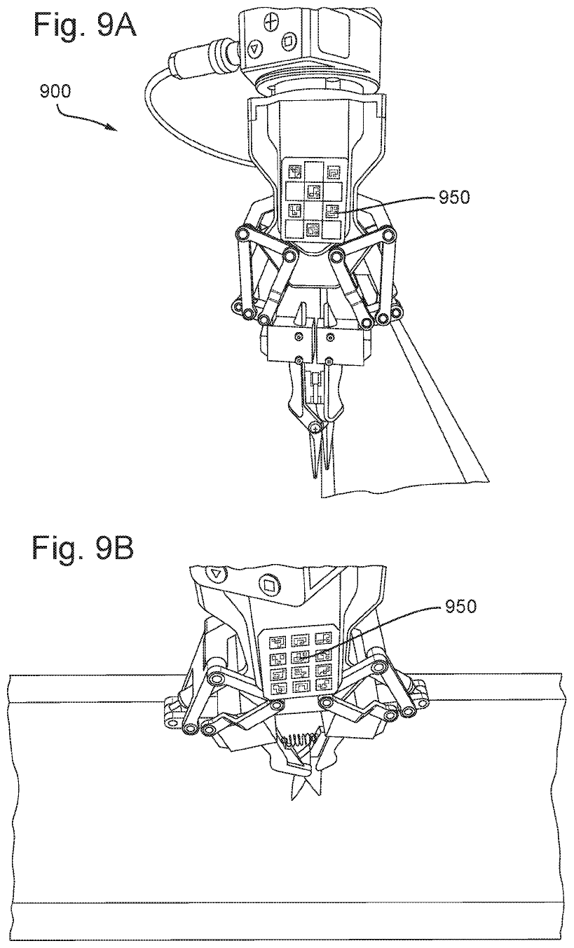

A ChArUco board tries to combine the benefits of these two approaches. For more information see Calibration with ArUco and ChArUco—OpenCV documentation.” https://docs.opencv.org/4.5.2/da/d13/tutorial_aruco_calibration.html. FIG. 9A shows a perspective view of an example end effector 900 with ChArUco calibration board 950 for use with embodiments of the present disclosure. The ArUco part is used to interpolate the position of the chessboard corners, so that it has the versatility of marker boards, since it allows occlusions or partial views. Moreover, since the interpolated corners belong to a chessboard, they are very accurate in terms of subpixel accuracy.

When high precision is necessary, such as in camera calibration, ChArUco boards are a better option than standard ArUco boards. Preferably embodiments of the disclosure use ChArUco boards due to their higher accuracy. FIG. 9B shows a perspective view of the example end effector of FIG. 9A with a superimposed pose estimation result from calibration board detection (using ArUco). It will be understood that embodiments of the disclosure may involve such a calibration operation being performed by the controller 160, for example on a periodic basis (e.g. once a day or every four hours etc.).

The system may be configured to perform an image analysis on an image of an item to obtain an indication of one or more of the following properties: (i) a colour of the item, (ii) a size of the item, (iii) a type of the item, and/or (iv) the presence of a defect in the item (e.g. which would render the item unsuitable for packing).

As to the colour of the item, the controller 160, 260, 760 may be configured to process the image to identify the region of the image in which the item is located. The system may be arranged so that the item is always in a similar region of the image (e.g. the timing of the operation of the cameras 155, 755a-d and/or conveyors 130, 230a, 230b, 240, 728, 730a-b, 740 may be controlled so that the item is within a selected region for photographing by the camera). The controller 160, 260, 760 may be configured to determine the colour of the item based on pixel values for the image (e.g. a red value for the relevant pixels). Determining the colour may comprise identifying a range of colours within which the item lies. For example, there may be industry standardised colour charts for items of fruit and/or vegetables, such as tomato colour charts (e.g. British Tomato Growers Association colour chart). The controller 160, 260, 760 may be configured to process the image to determine to which colour group of the different colour groups the item belongs. This processing may comprise use of one or more calibrations, such as having a reference colour in the background of the image which has a known colour value against which the colour of the item may be calibrated.

The controller 160, 260, 760 may control operation of the system based on the determined colour for the item. The controller 160, 260, 760 may determine, based on the colour, whether the item is suitable for packing. The controller 160, 260, 760 may determine, based on the colour, into which open container the item should be placed. For example, items may be grouped into a container 142, 742 so that all of the items in that container are of a similar colour. In which case, each open container 142, 742 may have an associated colour range (e.g. as stored in a data store of the controller). The controller 160, 260, 760 may be configured to identify the colour of an item, and then to place that item into an open container associated with that colour. As another example, items may be grouped into a container so that each container has items of a variety of different colours, such as according to prescribed criteria (e.g. white grapes and red grapes). In which case, each open container may have associated criteria for the colour of items it requires. The data store 164 may store an indication of these requirements, and each time an item is placed into a container, the data store 164, 764 is updated to indicate that said container 142, 742 has received an item of that colour. The controller 160, 260, 760 may be configured to obtain an indication of colour for an item, to determine which open container 142, 742 requires an item of that colour, and to control the second robotic arm 114, 714 to place the item into said open container 142, 742 (e.g. into the furthest advanced open container requiring an item of that colour).

As to the type of item, the controller 160, 760 may be configured to process the image of the item to determine its type (e.g. what type or category of fruit or vegetable it is). The system may be operated to receive two or more types of fruit/vegetables and to sort and/or pack these concurrently. The controller 160, 260, 760 may be configured to process the obtained image of each item and determine therefrom what type of item it is. Determining what type of item it is may comprise determining that the item is one type of item out of a selected list of possible items to be processed. For example, there may be a prescribed number of possible items to be processed, and the image processing may identify which of said prescribed items the item in question most closely resembles. The controller 160, 260, 760 may be configured to control operation of the second robotic arm 114, 214, 714 based on the determined type of item. For example, open containers 142, 742 may have one or more associated items, and the controller 160, 760 is configured to determine into which open container 142, 742 to place the item based on the type of item and open containers associated with that type of item.

As to the presence of a defect in the item, the system may be configured to process the image of the item to determine if there are any visible defects with the item. For example, the controller 160 may identify one or more regions on the surface of the item which deviate from what would be expected (e.g. in shape or colour etc.). These may indicate the presence of a blemish or other deformity with the item. As with the examples above, the controller 160 may be configured to control operation of the second robotic arm 114, 214, 714 to place the item into an open container 142, 742 selected based on whether or not there are any defects associated with the item.

The controller 160, 260, 760 may be configured to infer additional properties for the item based on the obtained data for the item, and/or the controller 160, 260, 760 may be configured to determine additional properties for the item based on a combination of obtained data for said item.

As one example, the controller 160, 260, 760 may be configured to determine an indication of ripeness for the item. The controller 160, 260, 760 may then sort items into open containers 142, 742 based on their ripeness. For example, each open container may have an associated level of ripeness, and the controller 160, 260, 760 may allocate items to open containers based on the determined indication of ripeness of the item (e.g. so that each container receives items of the required ripeness for that container). The controller 160, 260, 760 may be configured to provide an indication of ripeness for each full container, which may be used to control subsequent use of said container (e.g. to provide a use by date etc.).

The controller 160, 260, 760 may be configured to determine an indication of ripeness based on one or more obtain properties of the item. For example, an indication of ripeness may be obtained using the obtained colour for the item. In which case, sorting items based on their ripeness may comprise sorting items based on their colour. The controller 160, 260, 760 may be configured to determine ripeness by combining multiple pieces of obtained data for the item. For example, the controller 160, 260, 760 may obtain an indication of size for the item using image data, and this may be compared to pressure/displacement data obtained for the digits. The controller 160, 760 may determine an indication of ripeness based on a comparison between: (i) the displacement at which the digits hold the item with pressure in the selected range, and (ii) the determined size of the item obtained using the image data. This combination may provide an indication of how firm the item is. In other words, the controller 160, 260, 760 may be configured to determine and indication of ripeness/firmness for an item based on a comparison between an estimated size for the item determined using image data and a measured size for the item when held by the digits. The controller 160 may control operation of the second robotic arm 114, 214, 714 to sort and/or pack the item based on its determined ripeness. Ripeness may be detected using a sensor configured to sense ethylene.

The controller 160, 260, 760 may be configured to determine one or more properties about the item based on the obtained indication of the type of item and additional data. For example, the controller 160, 260, 760 may determine the ripeness based on the type of item (e.g. pear) and the colour of that item (e.g. how red/green the pear is). As another example, the controller 160, 260, 760 may determine what the item to be sorted is (e.g. a tomato) based on image analysis of that item. The controller 160, 260, 760 may determine how to sort the item based on colour based on the type of item, such as to identify selected colour ranges associated with that type of item, and to sort the item according to those selected colour ranges for that type of item.

Embodiments of the present disclosure may utilise one or more machine learning elements to determine the suitability of an item for sorting and/or packing into an open container. The machine learning element may be configured to process an image of an item (e.g. as obtained using one or more of the cameras) and to provide an output indicative of the suitability of that item for sorting and/or packing. For example, the machine learning element may comprise a convolutional neural network.

Training a machine learning element may comprise supervised training in which the element is provided with a plurality of items of input data, each of which being an image of an item having one or more associated properties. For example, when training for colour detection, each input item may be a photo of an item have an associated colour group out of a selection of available colour groups. The element may be trained using a large number of images. In each image, the item will have a known colour group associated therewith, against which the element's predictions may be tested and updated accordingly. Other properties of input items in images will vary in the training data set. In particular, the training data set will include a plurality of items of different shapes and sizes, as well as items in different levels of lighting, at different angles to the camera, and with different surface shading, patterning and/or contouring. The element may therefore be trained to correctly identify colour in items to a high degree of reliability for the vast majority of items likely to pass through the system 100, 200, 700.

As noted above, embodiments of the present disclosure may utilise a pressure sensing assembly comprising one or more pressure sensors to obtain a pressure measurement for contact between the digits of an end effector such as the at least one second end effector 122 and the item of fruit or vegetable, as described for example with reference to FIG. 4 which shows pressure sensing means 485 on the at least one second end effector 222. It is to be appreciated in the context of the present disclosure that any suitable pressure sensor may be used such as strain gauge-based pressure sensing or piezoelectric pressure sensing. Each digit may have a pressure sensor on its item-facing (and contacting) surface. The pressure sensor may be arranged to enable it to measure the pressure of the interaction of the respective digit holding the item.

The system may be configured to determine that an end effector is correctly holding the item based on a direction of contact pressure. For example, if the spatial distribution of contact pressures indicates that the item has an even distribution of contact pressure with the digits, e.g. if all, or a majority, of the contact pressure measurements are within a selected range from one another, it may be determined that the item is held correctly. The system may be configured to determine that an end effector is correctly holding the item based on an indication of whether the item is moving relative to the digits. For example, if it is determined that the item is stationary, e.g. moving below a threshold speed, relative to the digits, then it may be determined that the item is held correctly.

The pressure sensing assembly may comprise a plurality of different contact sensing locations on one or more of the digits. In other words, the pressure sensing assembly may comprise a plurality of spatially distributed pressure sensors. This distribution of pressure sensors may be configured to obtain a spatial distribution of contact pressure for contact between the digits of the end effector and an item held by the digits. This spatial distribution of contact pressure may comprise an indication of a magnitude of contact pressure for contact between at least one of the digits and the item held by the digits. The spatial distribution of contact may comprise a plurality of such magnitudes of contact pressure for contact at each of a plurality of different locations. Based on the plurality of different contact pressure sensing measurements, an indication of a direction of contact pressure for contact between the at least one item and the digits may be obtained. This indication of a direction of contact pressure may comprise an indication of how contact pressure varies across different regions of the surface of the item. This may also provide an indication of higher and lower pressure regions, and this may provide an indication of directionality for pressure between the digits and the item. For example, if two adjacent sensors have different contact pressures, this may indicate that one is gripping tighter than the other, e.g. because one of the sensors is on a digit which is in the wrong place, and/or the shape of the item may be such that the pressure distribution is not even for contact with said item. The spatial distribution of contact pressure may provide an indication of a direction in which one or more of the digits could move relative to the item to get a better grip on the item (e.g. so that the item is no longer moving, or contact pressure between the digits and the item is more evenly distributed about the items surface).

The plurality of contact pressure sensing locations are configured to repeatedly (e.g. continuously) provide contact pressure sensing data. For example, each contact pressure sensing location may comprise a piezoresistive sensor configured to monitor a voltage drop associated with contact in that contact sensing region. The plurality of contact sensors are arranged to enable detection of movement of the item relative to the digits. For example, the contact sensing regions may be distributed about the one or more digits to provide an indication of pressure for the majority or all of the contact area of the digit. The system may be configured to monitor the spatial distribution of pressure, and how this changes over time, to determine if an item is moving. For example, if pressure in one region is decreasing (e.g. consistently decreasing, or has moved to a low value), it may be inferred that the item is moving away from that region (and thus there is no contact, i.e. contact pressure, between the digit and the item in that region).

The system may be configured to determine that an item is not held correctly if, based on sensor signals from the pressure sensing assembly, it is determined that at least one of: (i) a magnitude of contact pressure (e.g. from one or more of the contact pressure sensing regions) has changed by more than a first amount; (ii) a magnitude of contact pressure (e.g. from one or more of the contact pressure sensing regions) is changing by more than a first rate of change; (iii) a direction of contact pressure has changed by more than a second amount; (iv) a direction of contact pressure is changing by more than a second rate of change; (v) a magnitude of contact pressure is changing while the indication of the direction of contact pressure remains constant; (vi) a direction of contact pressure is changing while the indication of the magnitude of contact pressure remains constant; (vii) the item is moving at more than a threshold speed relative to the digits of the end effector; and (viii) the item has moved more than a threshold distance relative to the digits of the end effector.

Where the magnitude of contact pressure in a contact region is outside a selected range, the corresponding digit may be moved relative to the item so that the contact pressure is in the selected range. If the contact pressure between a digit and the item is too high, that digit may be moved away from the digit until the contact pressure is within the selected ranged, and vice versa.

Where the direction of contact pressure indicates a non-uniform distribution of pressure on the item, one or more of the digits may be moved to balance the distribution of pressure to the item. If one or more of the contact pressure sensing regions indicate a contact pressure which is outside a selected range from contact pressures from other contact pressure sensing regions (e.g. too high or too low), the digit may move relative to the item to provide a more balanced spatial distribution of contact pressure. This may comprise moving the digit towards or away from the centre of the item, and/or moving the digit to a different location on the surface of the item. For example, the direction of contact pressure may suggest a higher contact pressure between one part of a digit than another part of that same digit. From this it may be inferred that the shape of the item is such that the digit is in the wrong place, e.g. the shape may be non-uniform. The digit may be controlled to move around the surface of the item to a location where the contact pressure distribution between that digit and the item becomes more uniform, e.g. so that any irregularities in shape are not impeding there being a consistent grip on the item (for example so that the item is being gripped in regions where its shape conforms more closely to the surface of the digits).

Where the sensor signals from the pressure sensing assembly indicates that the item is moving relative to the digits, the digits may be controlled to stop this movement. For example, the digits may be controlled to grip the item more tightly to prevent movement. For example, the digits may be moved in a direction based on the direction of movement of the item, e.g. so that the digits are in a position to oppose this movement of the item. Detection of movement may be based on the magnitude of contact pressure in different regions and/or an indication of direction for the contact pressure.

Embodiments of the present disclosure may utilise an electronic skin for the digit to provide pressure sensing. For example, each digit may have an electronic skin thereon. The electronic skin may cover the region of the digit which comes into contact with the item during use. The electronic skin may be made from a substrate comprising a base polymer layer, with a first intermediate polymer layer attached to the base polymer layer by a first adhesive layer. The first intermediate polymer layer may comprise a first intermediate polymer in which electron-rich groups are linked directly to one another (or e.g. these may optionally be substituted by C₁₋₄ alkanediyl groups). The skin may further include a first conductive layer attached to the first intermediate polymer layer by a second adhesive layer or by multiple second adhesive layers between which a second intermediate polymer layer or a second conductive layer is disposed. Nanowires may be present on the first conductive layer. The nanowires may comprise a piezoelectric material. Said nanowires may be provided to enable piezoelectric pressure sensing.

In the above described examples, a contact pressure sensing assembly is provided to obtain an indication of a contact pressure between a digit and an item held by that digit. Contact pressure sensors of the present disclosure may comprise piezoresistive sensors. However, it is to be appreciated in the context of the present disclosure that piezoelectric sensors may be used instead of, or in addition to, piezoresistive sensors. Although not shown in the Figs., an example of a contact pressure sensing assembly will now be described in which both piezoresistive and piezoelectric sensors are used.

Such a contact pressure sensing assembly includes a plurality of piezoresistive sensors and a plurality of piezoelectric sensors. The sensors may be provided as part of an electronic skin. The electronic skin may be affixed to one or more end effectors (e.g. digits) coupled to a robotic arm. In this example, the one or more end effectors and robotic arm will be similar to those described above with reference to FIGS. 1 to 8. That is, there may be a plurality of end effectors in the form of digits. The digits may be movable relative to one another to hold an item therebetween. The electronic skin is arranged to be affixed to said digits, e.g. it may be adhered (or affixed in another way) to the digits to cover a majority (if not all) of an item contacting portion of the digits. For example, the electronic skin may be configured to cover the digits so that any contact between the digits and the item will include contact between the electronic skin and the item.

The piezoresistive and piezoelectric sensors are spatially distributed about the electronic skin. The sensors may therefore be spatially distributed about the digits, so that each digit comprises one or more piezoresistive sensor, and one or more piezoelectric sensor. Typically, each digit will comprise a plurality of each type of the sensor, e.g. so that the sensors may obtain measurements for a plurality of different regions on the sensor (so that contact pressure sensing may be provided for the majority of the surface of the digits which contact items). For example, the contact pressure sensing assembly may be configured to obtain a plurality of different piezoelectric and piezoresistive sensor measurements for each digit (e.g. for different regions of each said digit).

Each of the sensors is connected to a controller such as controller 160 to enable an indication of a value for one or more parameters of the piezoresistive/piezoelectric signals to be obtained. The controller 160 is configured to control operation of the robotic arm and digits in the manner described above. That is, the controller may obtain (e.g. determine) an indication of properties such as: a magnitude of contact pressure, a direction of contact pressure and/or whether the item is moving relative to the digits, and to control operation of the arm and digits based on such indications.

For example, the contract pressure sensing assembly may be configured to monitor parameters of a voltage of the piezoresistive signals, such as a voltage drop associated therewith, to obtain an indication of a contact pressure with the item. Using the plurality of piezoresistive sensors, the system may be configured to obtain a spatial distribution of contact pressures between the digits and the item. Monitoring the piezoresistive signals may enable real-time pressure monitoring to occur and monitoring the piezoresistive signals may enable a spatial distribution of pressure for the item to be obtained.

The contact pressure sensing assembly may be configured to monitor parameters of a voltage of the piezoelectric signals to obtain an indication of a contact pressure with the item. The system may be configured to monitor any change in voltage for the piezoelectric signal. For example, the system may be configured to monitor any voltage extrema (e.g. maxima or minima for voltage), and/or any change in voltage (e.g. change by more than a threshold amount and/or change at more than a threshold rate). The system may be configured to determine at least one of: (i) a magnitude of any extrema, (ii) a rate of change in the voltage signal, (iii) an absolute value for change in the voltage signal, (iv) a phase associated with an extrema (e.g. peak or trough) in the voltage signal.

The system may be configured to compare different piezoelectric signals to identify any differences between such signals. For example, the system may be configured to compare a piezoelectric signal from a piezoelectric sensor on a first digit with a piezoelectric signal from a piezo electric signal on a second digit, or with a piezoelectric signal from a different piezoelectric sensor on the first digit. The system may be configured to identify one or more regions of interest in the piezoelectric signals. For example, these regions of interest will typically comprise one or more extrema (peaks or troughs), as these may provide an indication of a pressure value. The system may also be configured to monitor piezoelectric signals over time, as changes in the extrema (e.g. changes in their value, or changes in their position) may provide an indication of whether the item is correctly held. For example, the system may be configured to determine that an item is moving relative to the digits in the event that there is a change in one or more voltage extrema for the piezoelectric signals (e.g. in a given time window).

The system may be configured to monitor a position of extrema in the voltage signals from the piezoelectric sensors. The system may be configured to compare the positions for extrema in voltage signals from different sensors to determine both an indication that the item is moving, and also optionally a direction in which the item is moving. For example, the system may be configured to determine a direction of movement for the item based on a difference in phase between the different voltage signals. For example, the system may be configured to determine a direction of movement based on a difference in argument (e.g. sign—positive or negative) for the voltage extrema. For example, a negative sign may indicate movement away and positive movement towards.

The system may be configured to use such piezoelectric sensing to determine an indication of one or more properties of the contact pressure between the digits and the item, such as an indication of a magnitude and/or direction of that pressure, as well as an indication of whether the item is moving relative to the digits. Additionally, the system may be configured to utilise the one or more piezoresistive sensors in combination with said piezoelectric sensors.

It is to be appreciated in the context of the present disclosure that the piezoelectric sensors may provide complementary contact pressure data to that obtained using the piezoresistive sensors. For example, piezoelectric sensors may have a quicker response time, e.g. they may be more time-sensitive to pressure changes. As such, an indication of a change in pressure may first be observed with reference to the piezoelectric signals. It will be appreciated that piezoelectric sensors measure a charge brought about by a force applied to the piezoelectric material. This charge may leak over time (e.g. due to imperfect insulation/internal resistances of sensors and other electrical components connected thereto etc.). However, piezoresistive signals may be maintained over time.

The system may therefore be configured to determine an ongoing indication of contact pressure for the item using piezoresistive sensors. As such, an indication of a magnitude of pressure at any given moment may be obtained using the piezoresistive sensors. The system may be configured to monitor the piezoelectric signals to identify any changes, e.g. which indicate a change in pressure/movement of the item. The system may be configured so that, in the event that a change in pressure/movement of the item is detected in one or more piezoelectric signals, the piezoresistive signals corresponding to a similar region/digit to those piezoelectric signals will then be monitored to determine a magnitude of the pressure brought about by this change/movement. The robotic arm/end effectors may therefore be controlled based on read outs from both sensors. For example, the end effectors may be initially controlled based on the piezoelectric signal (e.g. to increase/decrease the tightness of their grip—the pressure they apply). The system may then monitor the contact pressure for the relevant region of the item using the piezoresistive sensors to ensure that the contact pressure remains within a selected range. This may enable the system to be more responsive to changes in grip while still ensuring that the grip of the item is not too tight or loose.

The system may be configured to determine how to change its grip (e.g. in response to a change indicated in one or more piezoelectric signals) based on a comparison between different piezoelectric signals. For example, in the event that it is determined that the item is moving in a first direction, the system may be controlled so that one or more of the digits moves position, wherein that movement is controlled based on the determined first direction. For example, a digit may be moved into a position where it counters that movement, e.g. to ensure that the item is held in a stationary manner between the digits.

It is to be appreciated in the context of the present disclosure that the above-described examples of contact pressure sensing assemblies are not to be considered limiting. Instead, this description provides exemplary functionality of the system for controlling the operation of the end effectors/robotic arm when placing items into item containers.

In some examples, the system may also include a displacement sensor. However, it is to be appreciated in the context of the present disclosure that a displacement sensor is not essential, as movement of items may be controlled based on sensor signals from the pressure sensing assembly. The displacement sensor may be operable to provide an indication of the displacement between digits, and/or an indication of displacement of an digit from a reference point (e.g. a central location). The displacement between digits may be determined using coordinates associated with the movement of the digits. For example, displacement of the digits could be calibrated to a first position (e.g. when they are touching, or at maximum separation), then each time an digit is controlled to move, the position or relative displacement of the digits is updated based on this movement. A camera and image analysis could be used to determine the displacement between digits, as could other displacement sensing technology. The displacement sensing may be used in combination with sensors from the pressure sensing assembly to enable an indication of a size of the item being grasped to be obtain. It will be appreciated that the size to be measured may vary depending on the type of item. For example, a diameter of the item may be used for circular-shaped items such as tomatoes. Depending on the number and/or arrangement of digits, this size may correspond directly to the displacement between two digits or it may be determined based on relative displacement of the digits, e.g. based on a geometric relationship between the digits. For example, where the object is circular, a diameter of the object may be determined based on the displacement of any one digit from its central point (i.e. where radius is zero).

In some examples, systems of the present disclosure may comprise a pressure sensor and a displacement sensor. The pressure sensor may be configured to obtain an indication of a contact pressure between the item and the one or more end effectors, and the displacement sensor may be configured to obtain an indication of a relative displacement between the different end effectors. For example, the system need not comprise a pressure sensor configured to obtain both an indication of a magnitude and a direction of contact pressure, e.g. only a magnitude of contact pressure may be obtained. The system may be configured to control operation of the robotic arm and end effectors based on pressure data (e.g. an indication of magnitude of pressure) and displacement data in the manner described above for the combination of pressure and displacement data.

For example, the system may be configured to determine that an end effector such as the at least one second end effector 122, 222, 722 is correctly holding the item based on a comparison of an indication provided by the pressure sensor with an indication provided by the displacement sensor. The size of the item may be determined based on this comparison.

In examples where a displacement sensor is included, determining whether or not an end effector is correctly holding the item may be based on more than one measurement for pressure and/or displacement. The system may be configured to monitor pressure and/or displacement values over time to identify if the end effector is correctly holding the item. The system may be configured to determine that incorrect holding is happening if one or both of the pressure and displacement values are changing over time (e.g. rate of change is above a threshold rate of change, or total change is above a threshold value).

In examples where a displacement sensor is included, if the pressure decreases while the displacement remains constant, it may be determined that the item is moving (e.g. slipping) or shrinking (e.g. it has been burst or overly-compressed), and the displacement may need to be reduced to ensure there is sufficient pressure to hold the item. If the pressure increases while the displacement remains constant, it may be determined that the item is moving (e.g. into a narrower region of the end effector) or is expanding (e.g. due to too much pressure in one or more regions of the item), and the displacement may need to be increased to inhibit damage to the item. If the displacement decreases while the pressure remains constant, it may be determined that the item is being compressed or has moved, and the displacement of the digits may need to be controlled to reduce the pressure. If the displacement increases while the pressure remains constant, it may be determined that the item is expanding or has moved, and that the digits may need to be controlled to increase the pressure.

In examples where a displacement sensor is included, the system may be configured to control operation of the digits based on both pressure and displacement. The system may be configured to control operation so that one of pressure or displacement remains in a selected range (e.g. remains constant, or at least substantially constant). For example, the separation of the digits may be controlled so that the pressure they exert on the item remains in a selected range. As another example, the pressure exerted by the digits may be controlled so that the displacement between them remains in a selected range. The selected ranges for pressure and/or displacement may be selected based on the relevant items of fruit and/or vegetables. For example, the system may be configured to receive an indication of one or more items of fruit and/or vegetables which are to be packed, and the corresponding range of pressure/displacement values may be selected for these items. Based on an indication of displacement, it may be determined what item is to be grasped, and the displacement/pressure thresholds selected accordingly.

Examples described herein may include systems and methods which use one or more displacement sensors to determine a displacement between the digits of an end effector. It is to be appreciated in the context of the present disclosure that any suitable displacement sensor may be used. Examples described may utilise information from a robotic arm which has controlled the separation of the digits. However, this is just one example, and this displacement may be measured in other ways. For example, a camera could be used, such as one of the first to third cameras. The camera may process an image of the digits to determine their separation. In other examples, no displacement sensor may be used at all.

Each robotic arm may have three degrees of freedom. Exemplary robotic arms (e.g. for the first or second robotic arm) may comprise a robotic arm sold under the trade name Elfin 5 produced by Hans Robot, such as the Elfin5.19 or Elfin5.21. Embodiments of the present disclosure may utilise one or more 3-dimensional cameras, such as those sold under the trade name of MV-CA050-10GC produced by HIKrobotics.

It will be appreciated from the discussion above that the examples shown in the figures are merely exemplary, and include features which may be generalised, removed or replaced as described herein and as set out in the claims. With reference to the drawings in general, it will be appreciated that schematic functional block diagrams are used to indicate functionality of systems and apparatus described herein. In addition, the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some examples the function of one or more elements shown in the drawings may be integrated into a single functional unit.

As will be appreciated by the skilled reader in the context of the present disclosure, each of the examples described herein may be implemented in a variety of different ways. Any feature of any aspects of the disclosure may be combined with any of the other aspects of the disclosure. For example, method aspects may be combined with apparatus aspects, and features described with reference to the operation of particular elements of apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Furthermore, equivalents and modifications not described above may also be employed without departing from the invention.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates. Controllers described herein may be provided by any control apparatus such as a general-purpose processor configured with a computer program product configured to program the processor to operate according to any one of the methods described herein.

Machine learning elements described herein may be provided in a number of forms. This may include computer program instructions configured to program a computer processor to operate according to the instructions. The instructions may comprise a finalised machine learning element such that a user may not be able to alter or identify properties associated with the element, or the instructions may be arranged so that they can be overwritten so that continued use of the machine learning element may enable the code to be updated (so as to further develop the element). As will be appreciated in the context of the present disclosure, the specific nature of the machine learning element is not to be considered limiting, and this may vary depending on the nature of data to be processed. Any suitable system for the provision of a machine learning element may be utilised.

The machine learning element may comprise a neural network. A neural network may include a plurality of layers of neurons, where each neuron is configured to process input data to provide output data. It will be appreciated that any suitable process may be provided by any given neuron, and these may vary depending on the type of input data. Each layer of the network may include a plurality of neurons. The output of each neuron in one layer may be provided as an input to one or more (e.g. all) of the neurons in the subsequent layer. Each neuron may have an associated set of weightings which provide a respective weighting to each stream of input data provided to that neuron. Each path from a neuron to a neuron may be referred to as ‘an edge’. Weightings may be stored at each neuron, and/or at each edge.

Such a neural network may have at least two variables which can be modified to provide improved processing of data. Firstly, a neuron's functionality may be selected or updated. Systems and methods of neural architecture search may be used to identify suitable functionalities for neurons in a network. Secondly, the weightings in the network may be updated, such as to alter priorities of different streams of input and output data throughout the network.

The machine learning element may be trained. For example, training the machine learning element may comprise updating the weightings. A plurality of methods may be used to determine how to update the weightings. For example, supervised learning methods may be used in which the element is operated on an input data for which there is a known correct output. That input/output is provided to the machine learning element after it has operated on the data to enable the machine learning element to update itself (e.g. modify its weightings). This may be performed using methods such as back propagation. By repeating this process a large number of times, the element may become trained so that it is adapted to process the relevant data and provide a relevant output. Other examples for training the machine learning element include use of reinforcement learning, where one or more rewards are defined to enable elements to be trained by identifying and utilising a balance between explorative and exploitative behaviour. For example, such methods may make use of bandit algorithms. As another example, unsupervised learning may be utilised to train the machine learning element. Unsupervised learning methods may make use of principal component and/or cluster analysis to attempt to infer probability distributions for an output based on characteristics of the input data (e.g. which may be associated with known/identified outputs).

The specifics of the machine learning element, and how it is trained, may vary, such as to account for the type of input data to be processed. It will be appreciated that different types of machine learning element may be suited to different tasks or for processing different types of data. It will also be appreciated that data may be cast into different forms to make use of different machine learning elements. For example, a standard neural network could be used for processing numerical input data, such as empirical values from obtained measurements. For processing images, convolutional neural networks may be used, which include one or more convolution layers. Numerical data may be cast into image form, such as by using a form of rasterization which represents numerical data in image form. A standard file format may be used to which the resulting image must adhere, and a convolutional neural network may then be trained (and used) to analyse images which represent the measurements (rather than values for the measurements themselves). Consequently, the specific type of machine learning element should not be considered limiting. The machine learning element may be any element which is adapted to process a specific type of input data to provide a desired form of output data (e.g. any element which has been trained/refined to provide improved performance at its designated task).

It will also be appreciated by the skilled person that while embodiments have been described in the context of packing and manipulating bunches of grapes, embodiments of the disclosure may equally be applied to packing and manipulating other fruits and vegetables, in particular non-linear fruits and vegetables, for example vine fruits and vegetables such as bunches of bananas, tomatoes on the vine, blueberries and so on.

Other examples and variations of the disclosure will be apparent to the skilled addressee in the context of the present disclosure.

1. An item packing system configured to sort and/or pack vine fruit into containers, the system comprising:
a first robotic arm comprising at least one first end effector for cutting grapes from a bunch;
a second robotic arm comprising at least one second end effector for holding and manipulating a bunch of grapes for packing into a container;
at least one camera for providing image data of vine fruit; and
a controller configured to receive the image data of the vine fruit and to make a determination of the weight of the vine fruit based on the received image data;
wherein the controller is configured to control the at least one first end effector of the first robotic arm to cut the vine fruit based on the determined weight of the vine fruit; and
wherein the controller is configured to control the at least one second end effector of the second robotic arm to hold and manipulate the cut vine fruit into a container.

2. The item packing apparatus of claim 1 wherein the at least one second end effector comprises a pressure sensing assembly for providing an indication of a contact pressure and wherein the controller is configured to control the at least one second end effector of the second robotic arm to hold and manipulate the cut vine fruit into a container based on an indication of the contact pressure.

3. The item packing system of claim 1, wherein at least one camera is proximate to the first robotic arm, and wherein at least another camera is proximate to the second robotic arm, and wherein the controller is configured to receive image data of a cut vine fruit proximate to the second robotic arm and to make a determination of the weight of the cut vine fruit based on the received image data from the at least another camera, wherein the controller is configured to make a determination as to whether to pack the cut vine fruit into a container based on the determined weight of the cut vine fruit.

4. (canceled)

5. The item packing system of claim 1 further comprising a conveyor configured to convey the vine fruit to the first robotic arm and from the first robotic arm to the second robotic arm, and wherein the controller is configured to control the conveyor based on operation of the first robotic arm and/or the second robotic arm, wherein the controller is configured to control the conveyor based on control of at least one of the at least one first end effector of first robotic arm and/or the at least one second end effector of second robotic arm.

6. (canceled)

7. The item packing system of claim 5 further comprising a manipulating means arranged to flip the vine fruit such that a different face of the vine fruit is exposed to the at least one camera, and wherein the controller is configured to make a second determination of the weight of the vine fruit based on received image data relating to the different exposed face of the flipped vine fruit, wherein the controller is configured to compare the second determined weight of the vine fruit with the determined first weight of the vine fruit.

8. (canceled)

9. The item packing system of claim 1 further comprising a light detection and ranging, LIDAR, apparatus for determining a distance to the item and/or for determining the weight of the vine fruit.

10. The item packing system of claim 1 wherein the controller is configured to fil obtain point cloud information to determine the weight of the vine fruit, (ii) perform semantic image segmentation on the received image data to determine the location of stems or stalks relative to the fruit, and wherein the controller is configured to use the determined location of stems or stalks to control the at least one end effector of the first robotic arm to cut the vine fruit at a stem or stalk, and/or (iii) determine an orientation to hold the vine fruit in based on the received image data.

11. (canceled)

12. (canceled)

13. The item packing system of claim 2 wherein the controller is configured to receive sensor signals from the pressure sensing assembly of the second robotic arm to obtain an indication of:
(i) a magnitude of contact pressure for contact between the end effector and the item held by the end effector; and
(ii) a direction of contact pressure for contact between the end effector and the item held by the end effector; and
wherein the controller is configured to determine whether the end effector is correctly holding the item based on the indication of the magnitude of the contact pressure and the indication of the direction of contact pressure, wherein the system is configured to determine if the end effector is correctly holding the item if both: (i) the indication of the magnitude of contact pressure is within a selected pressure range, and (ii) the indication of the direction of contact pressure is within a selected direction range.

14. (canceled)

15. The item packing system of claim 13, wherein the system is configured to determine that the end effector is not correctly holding the item if at least one of:
(i) the indication of the magnitude of contact pressure has increased or decreased by more than a first amount;
(ii) the indication of the magnitude of contact pressure is increasing or decreasing by more than a first rate of change;
(iii) the indication of the direction of contact pressure has changed by more than a second amount; and
(iv) the indication of the direction of contact pressure is changing by more than a second rate of change.

16. The item packing system of claim 13, wherein the system is configured to determine that the end effector is not correctly holding the item if at least one of:
(i) the indication of the magnitude of contact pressure is changing while the indication of the direction of contact pressure remains constant; and
(ii) the indication of the direction of contact pressure is changing while the indication of the magnitude of contact pressure remains constant.

17. The item packing system of claim 13, wherein in the event that the controller determines that the one or more end effectors are not correctly holding the item, the controller is configured to control at least one of the end effectors to move relative to the item, wherein controlling at least one of the end effectors to move comprises at least one of:
(i) moving the end effector inwards to increase its contact pressure on the item in the event that the magnitude of contact pressure is too low;
(ii) moving the end effector outwards to decrease its contact pressure on the item in the event that the magnitude of contact pressure is too high; and
(iii) moving the end effector around the item to a different location on the surface of the item in the event that the direction of contact pressure is not in the correct direction.

18. (canceled)

19. The item packing system of claim 13 wherein in the event that the system determines that the one or more end effectors are not holding the item correctly, the system performs at least one of the following actions:
(i) rejects the item for review;
(ii) logs the rejection in a database, optionally with a timestamp;
(iii) triggers an alert notification;
(iv) returns the item to where it was picked, for example to enable further visual inspection of the item;
(v) attempts to obtain a new indication of the size of the item;
(vi) determines if the item is bruised or damaged; and
(vii) provides feedback for use in training a machine learning algorithm.

20. The item packing system of claim 2, wherein the pressure sensing assembly of the second robotic arm comprises an electronic skin made from a substrate comprising:
a base polymer layer;
a first intermediate polymer layer attached to the base polymer layer by a first adhesive layer, the first intermediate polymer layer comprising a first intermediate polymer in which electron-rich groups are linked directly to one another or by optionally substituted C₁₋₄ alkanediyl groups; and
a first conductive layer attached to the first intermediate polymer layer by a second adhesive layer or by multiple second adhesive layers between which a second intermediate polymer layer or a second conductive layer is disposed.

21-29. (canceled)

30. An end effector for a robotic arm for manipulating vine fruit, the end effector comprising:
a pair of opposing scoops coupled via a connecting portion, wherein each opposing scoop comprises a plurality of digits and wherein each digit comprises a pressure sensing means;
wherein the pressure sensing means are arranged to detect at least one of (i) the magnitude and (ii) the direction of pressure on each of the digits caused by the vine fruit.

31. The end effector of claim 30 wherein each digit comprises a curved fingertip comprising an extrusion configured to support vine fruit.

32. The end effector of claim 30 further comprising a controller, and wherein the controller is configured to control operation of at least one of the scoop and each digit based on the detected magnitude and/or direction of pressure, wherein the controller is configured to determine whether an end effector is correctly holding vine fruit based on an indication of whether the vine fruit is moving relative to the digits, and wherein the controller is configured to control the end effector to manipulate at least one of the digits in response to a determination that the end effector is not correctly holding the vine fruit, wherein the controller is configured to determine the approximate shape of the vine fruit based on the at least one of (i) the magnitude and (ii) the direction of pressure on each of the digits, and wherein the controller is configured to manipulate at least one of the scoops and/or each digit based on the determined approximate shape.

33. A method of sorting and/or packing vine fruit into containers by a robotic system, the robotic system comprising:
a first robotic arm comprising at least one first end effector for cutting vine fruit;
a second robotic arm comprising at least one second end effector for holding and manipulating vine fruit for packing into a container;
the method comprising:
receiving image data of the vine fruit;
making a determination of the weight of the vine fruit based on the received image data;
making a determination as to where to cut the vine fruit based on the determined weight of the vine fruit;
controlling the at least one first end effector of the first robotic arm to cut the vine fruit;
controlling the at least one second end effector of the second robotic arm to hold and manipulate the cut vine fruit into a container.

34. The method of claim 33 wherein the at least one second end effector comprises a pressure sensing assembly for providing an indication of a contact pressure and wherein the method comprises controlling the at least one second end effector of the second robotic arm to hold and manipulate the cut vine fruit into a container based on the indication of the contact pressure, wherein the at least one second end effector comprises a plurality of digits, the method further comprising:
receiving an indication of a magnitude of contact pressure of an item between the plurality of digits;
receiving an indication of a direction of contact pressure of an item between the plurality of digits;
determining whether the plurality of digits are correctly holding the item based on the indication of the magnitude of the contact pressure and the indication of the direction of contact pressure.

35. A computer readable non-transitory storage medium comprising a program for a computer configured to cause a processor to perform the method of claim 33.
